(19) United States
(12) Patent Application Publication
(10) Pub. No.: US 2007/0286968 A1
(43) Pub. Date: Dec. 13, 2007

(54) Compound, liquid crystal composition, and their applications

(75) Inventors: Hiroshi Takeuchi, Minami-ashigara-shi (JP); Aiko Yoshida, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/808,704

(22) Filed: Jun. 12, 2007

(30) Foreign Application Priority Data
Jun. 12, 2006 (JP) 2006-161884
Feb. 27, 2007 (JP) 2007-046759

(51) Int. Cl. C09K 19/12

(52) U.S. Cl. 428/1.1; 252/299.65; 428/1.31

(57) ABSTRACT

A novel compound is disclosed. The compound is represented by a formula (I) below:

Q¹-SP¹—X¹-A-B—C-D-X²—SP²-Q² (I)

where, Q¹ and Q² respectively represent a polymerizable group; SP¹ and SP² respectively represent a spacer group; X¹ and X² respectively represent a linking group; and A, B, C and D respectively represent a divalent group selected from formulae IIa, IIb and IIc below:

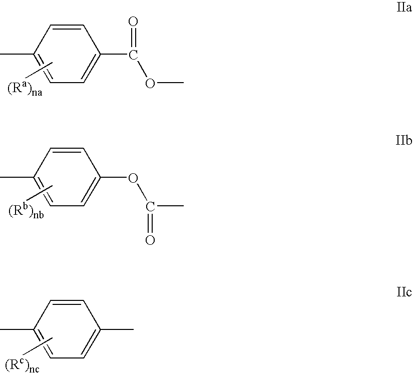

where, R^{a}, R^{b} and R^{c} respectively represent a substituent group, na, nb and nc respectively represent an integer of 0 to 4, a plurality of R^{a}, R^{b} or R^{c} may be same or different each other when na, nb and nc are respectively integers of 2 or more; provided that at least two of A, B, C and D is a divalent group represented by the formula IIa, or at least two of them is a divalent group represented by the formula IIb.

### CROSS-REFERENCE TO RELATED APPLICATIONS

This application claims benefit of priorities under 35 U.S.C. 119 to Japanese Patent Application Nos. 2006-161884 filed Jun. 12, 2006 and 2007-046759 filed Feb. 27, 2007; and their entire contents are incorporated herein by reference.

### BACKGROUND OF THE INVENTION

1. Field of the Invention

The present invention relates to a novel compound, and in particular to a novel compound having liquid crystallinity. The present invention also relates to a liquid crystal composition containing the compound, an anisotropic material obtained by stabilizing an alignment of the liquid crystalline composition, a protective film for a polarizer plate, an optical compensation film, and a liquid crystal display device employing the anisotropic material.

2. Related Art

Liquid crystal has effectively been used as an important material playing a role of shutter for light, in liquid crystal display devices such as so-called liquid crystal displays. Liquid crystal has also been used as a material of various optical compensation elements employed for improving display characteristics in liquid crystal displays, in particular display characteristics when observed in an oblique direction. Both of polymer liquid crystal and low-molecular-weight liquid crystal have been used as materials of such optical compensation elements, wherein low-molecular-weight liquid crystal is more excellent in adequacy of manufacturing, in terms of alignment speed, as compared with polymer liquid crystal. Low-molecular-weight liquid crystal is also advantageous in that an optical compensation element, produced by using it, exhibits hardly-changeable optical characteristics since such an optical compensation element is usually produced by aligning the liquid crystal, and then by stabilizing the alignment state via polymerization or the like.

An optical compensation element produced by using a low-molecular-weight liquid crystal material, it is usually produced by align liquid crystal in a state of a predetermined liquid crystal phase, and then by carrying out polymerization reaction or the like for curing. Previously, in such a method, liquid crystal is often aligned in a nematic phase state, and then stabilized in the state; however, the nematic phase has a relatively low order degree, and fluctuates thermally. For this reason, the optical compensation element produced by stabilizing liquid crystal in a state of a nematic phase, employed in a liquid crystal display for optical compensation, may sometimes result in light leakage in the black state, so that it is necessary to improve the optical compensation performance of the optical compensation element, in order to satisfy demands on higher quality images (in particular, higher contrast) in the market. As an optical compensation element improved in optical compensation performance, those produced by stabilizing a smectic phase have been proposed (Japanese Laid-Open Patent Publication Nos. H6-331826 and H10-319408, and Published Japanese Translation of PCT International Publication for Patent Application No. 2000-514202). Also various compositions exhibiting the smectic phase have been proposed (Published Japanese Translation of PCT International Publication for Patent Application No. 2001-527570, Japanese Laid-Open Patent Publication Nos. 2005-15406 and 2003-207631).

### SUMMARY OF THE INVENTION

The liquid crystal materials described in the aforementioned patent publications have, however, been still in need of improvement, due to insufficient stabilization of alignment via polymerization, or large dispersion of birefringence. As a liquid crystal material employed for producing an optical compensation element, the liquid crystal material preferably exhibits a wavelength-dispersion property almost equal to or better than that of a liquid crystalline material employed in a liquid crystal cell.

One object of the present invention is to provide a novel compound and a liquid crystal composition capable of exhibiting a state of a smectic phase and useful for producing an anisotropic material.

Another object of the present invention is to provide an anisotropic material having desirable performances, which can be produced in a stable manner without being affected by thermal fluctuation of the liquid crystal phase.

In one aspect, the invention provides a compound represented by a formula (I) below:

Q¹-SP¹—X¹-A-B—C-D-X²—SP²-Q² (I)

where, Q¹ and Q² respectively represent a polymerizable group; SP¹ and SP² respectively represent a spacer group; X¹ and X² respectively represent a linking group; and A, B, C and D respectively represent a divalent group selected from formulae IIa, IIb and IIc below:

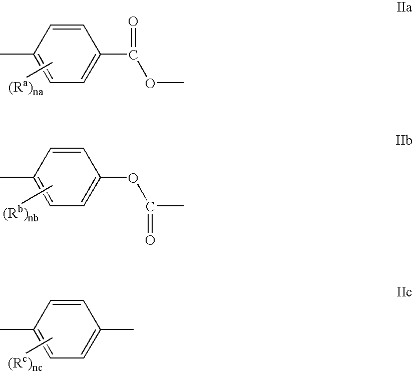

where, R^{a}, R^{b} and R^{c} respectively represent a substituent group, na, nb and nc respectively represent an integer of 0 to 4, a plurality of R^{a}, R^{b} or R^{c} may be same or different each other when na, nb and nc are respectively integers of 2 or more;

provided that at least two of A, B, C and D is a divalent group represented by the formula IIa, or at least two of them is a divalent group represented by the formula IIb.

As embodiments of the invention, there are provided the compound wherein Q¹ and Q² in the formula are represented by any one of the formulae (Q-101) to (Q-106) below:

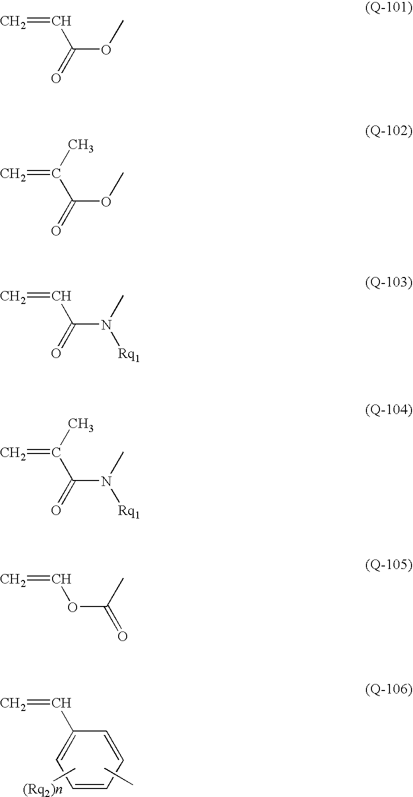

where, Rq1 represents a hydrogen atom, alkyl group, or aryl group; Rq2 represents a substituent group; and n is an integer of 0 to 4; the compound wherein -A-B—C-D- in the formula is a group selected from the group I below:

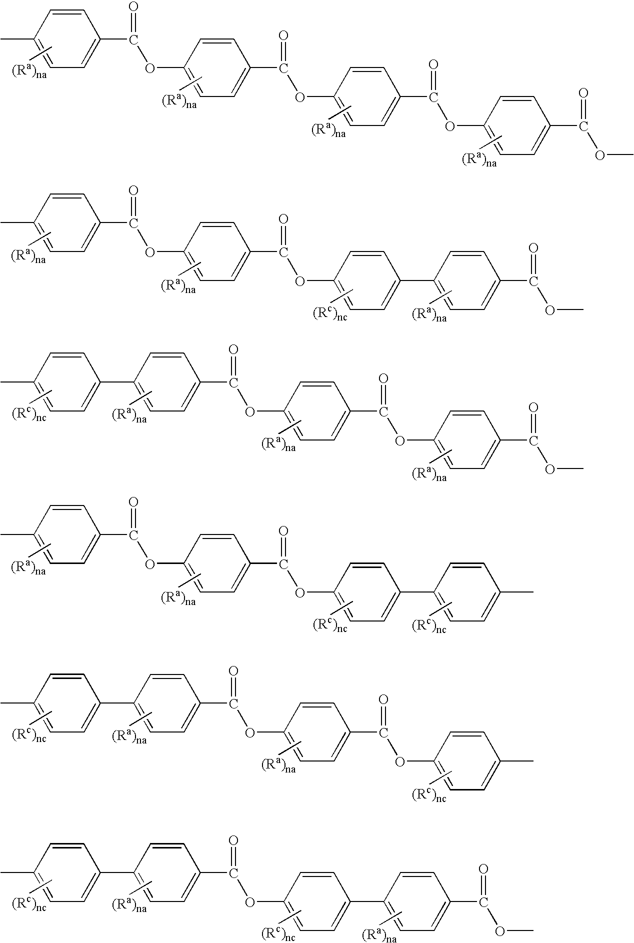

In another aspect, the invention provides a liquid crystal composition comprising at least one compound represented by a formula (I) below:

Q¹-SP¹—X¹-A-B—C-D-X²—SP²-Q² (I)

where, Q¹ and Q² respectively represent a polymerizable group; SP¹ and SP² respectively represent a spacer group; X¹ and X² respectively represent a linking group; and A, B, C and D respectively represent a divalent group selected from formulae IIa, IIb and IIc below:

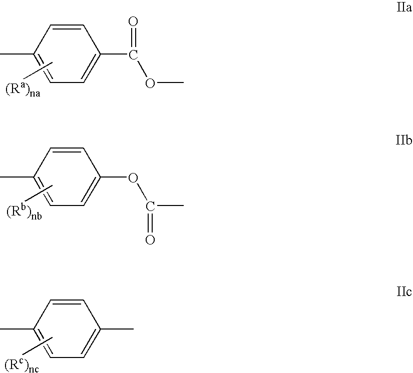

where, R^{a}, R^{b} and R^{c} respectively represent a substituent group, na, nb and nc respectively represent an integer of 0 to 4, a plurality of R^{a}, R^{b} or R^{c} may be same or different each other when na, nb and nc are respectively integers of 2 or more;

provided that at least two of A, B, C and D is a divalent group represented by the formula IIa, or at least two of them is a divalent group represented by the formula IIb; an anisotropic material formed by curing the liquid crystal composition; a protective film for a polarizer plate comprising the anisotropic material, an optical compensation film comprising the anisotropic material; and a liquid crystal display device comprising the protective film for a polarizer plate and/or the optical compensation film.

According to the present invention, it is possible to provide a novel compound and a liquid crystal composition capable of exhibiting a smectic phase and useful for producing an anisotropic material.

According to the present invention, it is possible to provide an anisotropic material having desirable performances, which can be produced in a stable manner without being affected by thermal fluctuation of the liquid crystal phase.

### DETAILED DESCRIPTION OF THE INVENTION

Paragraphs below will detail embodiments of the present invention. It is to be noted that the expression “to” in this specification means a range expressed by the numerals placed therebefore and thereafter as the lower limit value and the upper limit value, respectively.

The present invention relates to a compound represented by the formula (I) below.

Q¹-SP¹—X¹-A-B—C-D-X²—SP²-Q² (I)

In the formula, Q¹ and Q² respectively represent a polymerizable group; SP¹ and SP² respectively represent a spacer group; and X¹ and X² respectively represent a linking group.

In the formula, Q¹ and Q² independently represent a polymerizable group. The polymerizable group is preferably capable of addition polymerization (including ring-opening polymerization) or condensation polymerization, and is, in other words, preferably a functional group capable of addition polymerization or condensation polymerization. Examples of the polymerizable group are shown below.

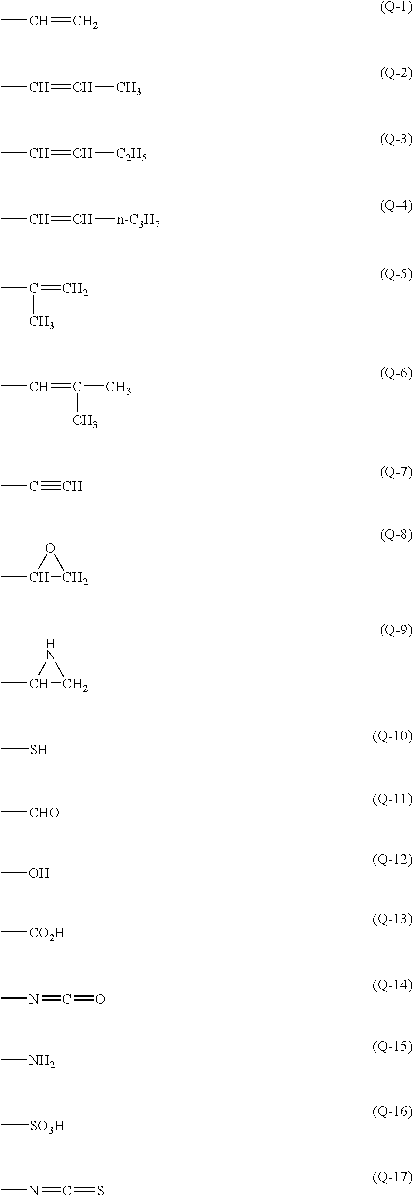

Each of polymerizable groups Q¹ and Q² preferably expresses or contains an unsaturated polymerizable group (Q-1 to Q-7), epoxy group (Q-8) or aziridinyl group (Q-9), or oxetanyl group, more preferably expresses or contains an unsaturated polymerizable group, and still more preferably an ethylenic unsaturated polymerizable group (Q-1 to Q-6). Examples of the ethylenic unsaturated polymerizable group (Q-1 to Q-6) further include those represented by the formulae (Q-101) to (Q-106) below. Among these, those represented by the formulae (Q-101) and (Q-102) are preferable.

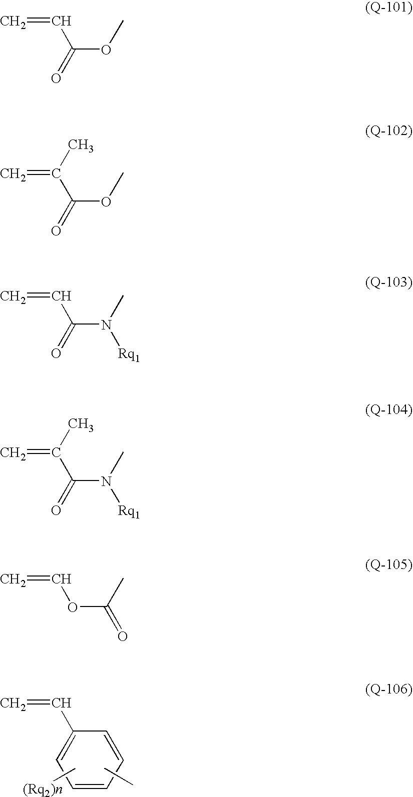

In the formulae, Rq1 represents a hydrogen atom, alkyl group, or aryl group, Rq2 represents a substituent group, and n represents an integer of 0 to 4. Rq1 is preferably a hydrogen atom, alkyl group having 1 to 5 carbon atoms, and aryl group having 6 to 12 carbon atoms, and more preferably a hydrogen atom and alkyl group having 1 to 3 carbon atoms, and still more preferably a hydrogen atom or methyl group. Preferable examples of the substituent group represented by Rq2 include those exemplified as examples of the substituent group R^{a}, R^{b} and R^{c}, described later. n is preferably an integer of 0 to 2, and more preferably 0 or 1.

In the formula (I), SP¹ and SP² independently represent a divalent spacer group. It is preferable that SP¹ and SP² are independently a divalent linking group selected from the group consisting of —O—, —S—, —CO—, —NR²—, divalent chain group and combinations of them. R² is an alkyl group having 1 to 7 carbon atoms or hydrogen atom.

The term “divalent chain group” means an alkylene group, substituted alkylene group, alkenylene group, substituted alkenylene group, alkynylene group or substituted alkynylene group. An Alkylene, substituted alkylene, alkenylene and substituted alkenylene groups are preferable, and an alkylene and alkenylene groups are more preferable. The alkylene group may be branched. The number of carbon atoms of the alkylene group is preferably 1 to 12, more preferably 2 to 10, and much more preferably 2 to 8. The alkylene portion of the substituted alkylene group is same as the above-described alkylene group. Examples of substituent group of the substituted alkylene group include alkoxy group and halogen atom. The alkenylene group may be branched. The number of carbon atoms of the alkenylene group is preferably 2 to 12, more preferably 2 to 10, and much more preferably 2 to 8. The alkenylene portion of the substituted alkenylene group is same as the above-described alkenylene group. Examples of substituent group of the substituted alkenylene group include alkoxy group and halogen atom. The alkynylene group may be branched. The number of carbon atoms of the alkynylene group is preferably 2 to 12, more preferably 2 to 10, and much more preferably 2 to 8. The alkynylene portion of the substituted alkynylene group is same as the above-described alkynylene group. Examples of substituent group of the substituted alkynylene group include alkoxy group and halogen atom. In the divalent chain group, one or more non-adjacent CH₂ groups may be substituted by —O—, —CO—O—, —O—CO—, —O—CO—O—, —CO— or —S—. The total number of carbon atoms of the spacer group is preferably 1 or more, more preferably 2 to 30, and still more preferably 4 to 20.

In the formula (I), X¹ and X² independently represent a divalent linking group. It is preferable that X¹ and X² independently represent a divalent linking group selected from the group consisting of single bond, —O—, —S—, —CO—, —NR²— (R² is same as described in the above) and combinations of them. More preferably, they represent —O—, —C(═O)—O—, —O—C(═O)—, —CO—NH—, —NH—CO— or —O—CO—O—.

In the formula (I), preferable examples of —SP¹—X¹— or —X²—SP²— include the groups below, without being limited thereto. In the specific examples below, “*” indicates a site of bonding to Q¹ or Q².

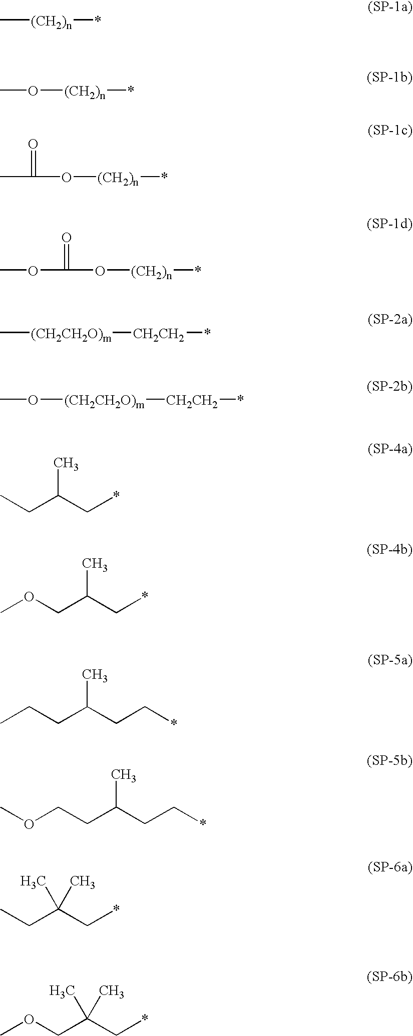

In the formula, n and m respectively represent an integer equal to or larger than 1. n is preferably an integer of 1 to 20, and more preferably an integer of 2 to 10. m is preferably an integer of 1 to 10, and more preferably an integer of 1 to 6.

In the formula (I), A, B, C and D respectively represent divalent group selected from those represented by the formulae IIa, IIb and IIc below, wherein at least two of A, B, C and D are represented by IIa, or at least two of them are represented by IIc.

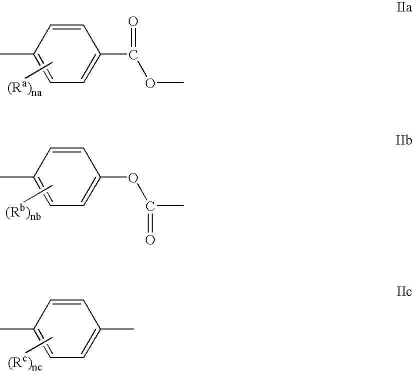

In the formulae, R^{a}, R^{b} and R^{c} respectively represent a substituent group, na, nb and nc respectively represent an integer of 0 to 4, provided that a plurality of R^{a}, R^{b} and R^{c} is identical or different each when na, nb and nc are respectively integers equal to or larger than 2.

Regarding the compound represented by the formula (I) having a plurality of ester bonds (—C(═O)O— or —OC(═O)—), the smectic phase becomes more likely to produce if the plurality of ester bonds have the same order of arrangement of atoms.

A structure having a divalent group represented by IIa as D and a single bond as X², and a structure having a divalent group represented by IIc as D and —C(═O)O— as X² are identical, and it is to be understood that such a structure is assumed as a structure having a divalent group represented by IIa as D and a single bond as X². Also for a structure having a divalent group represented by IIb as D and a single bond as X², and a structure having a divalent group represented by IIc as D and —OC(═O)— as X², the structure is to be assumed as the former.

At least one of A, B, C and D preferably has a substituent group (in other words, at least one of na, nb and nc is an integer of 1 or larger). Introduction of the substituent group can contribute to improvement in miscibility with other materials and in solubility into a solvent, and, then, in preparation as the liquid crystal composition. Alteration of the substituent group can also modify the phase transition temperature. Species of the substituent group can appropriately be selected, depending on desired physical properties. Examples of the substituent group respectively represented by R^{a}, R^{b} and R^{c} include a halogen atom, cyano, nitro, alkyl group having 1 to 5 carbon atoms, halogen-substituted alkyl group having 1 to 5 carbon atoms, alkoxy group having 1 to 5 carbon atoms, alkylthio group having 1 to 5 carbon atoms, acyl group having 1 to 5 carbon atoms, acyloxy group having 2 to 6 carbon atoms, alkoxycarbonyl group having 2 to 6 carbon atoms, carbamoyl, alkyl-substituted carbamoyl group having 2 to 6 carbon atoms and amide group having 2 to 6 carbon atoms. Preferable examples of the substituent include a halogen atom, cyano, alkyl group having 1 to 3 carbon atoms, halogen-substituted alkyl group having 1 to 3 carbon atoms, alkoxy group having 1 to 3 carbon atoms and acyloxy group having 2 to 4 carbon atoms.

According to the present invention, preferably, all of A, B, C and D are IIa or are IIa or IIc in terms of synthesis, and more preferably, they are IIa or IIc. Preferable examples of -A-B—C-D- are shown below. All examples shown below have the same order of arrangement of atoms in a plurality of ester bonds, and such molecular structure is considered as being more likely to form the smectic phase. As described in the above, it is to be understood that a plurality of R^{a}, R^{b}, R^{c}, na, nb and nc in the formula may be identical to, or different from each other.

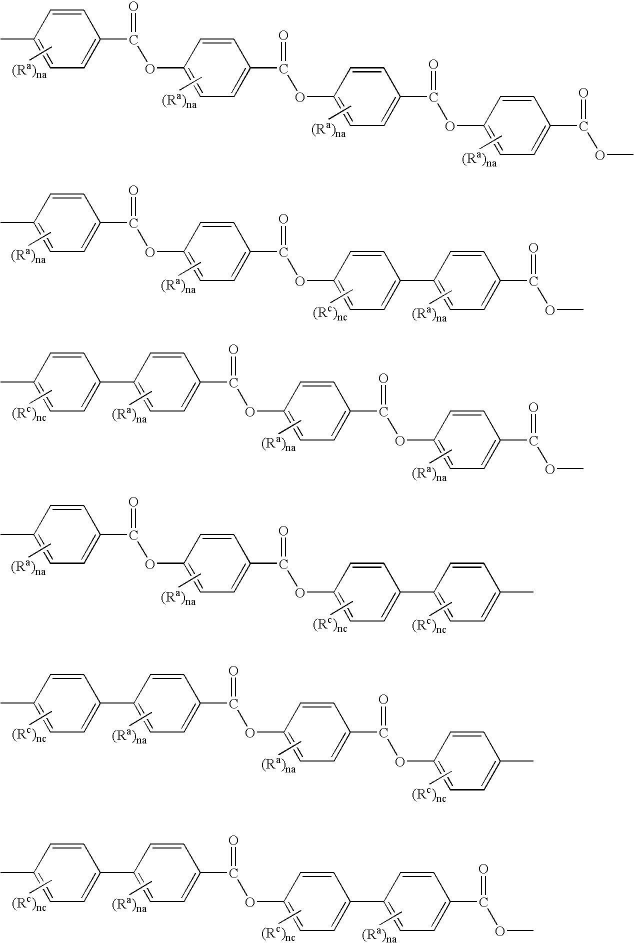

-A-B—C-D- also preferably has the structures below.

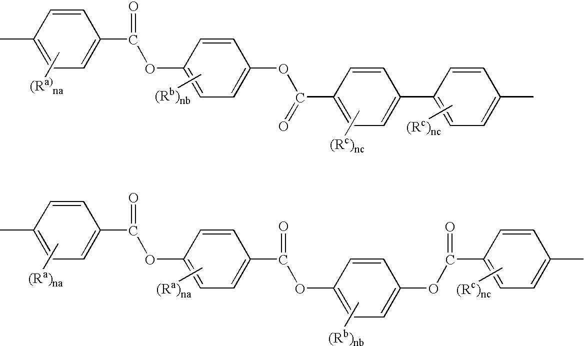

Examples of the compounds represented by the formula (I) include, but are not limited to, those shown below.

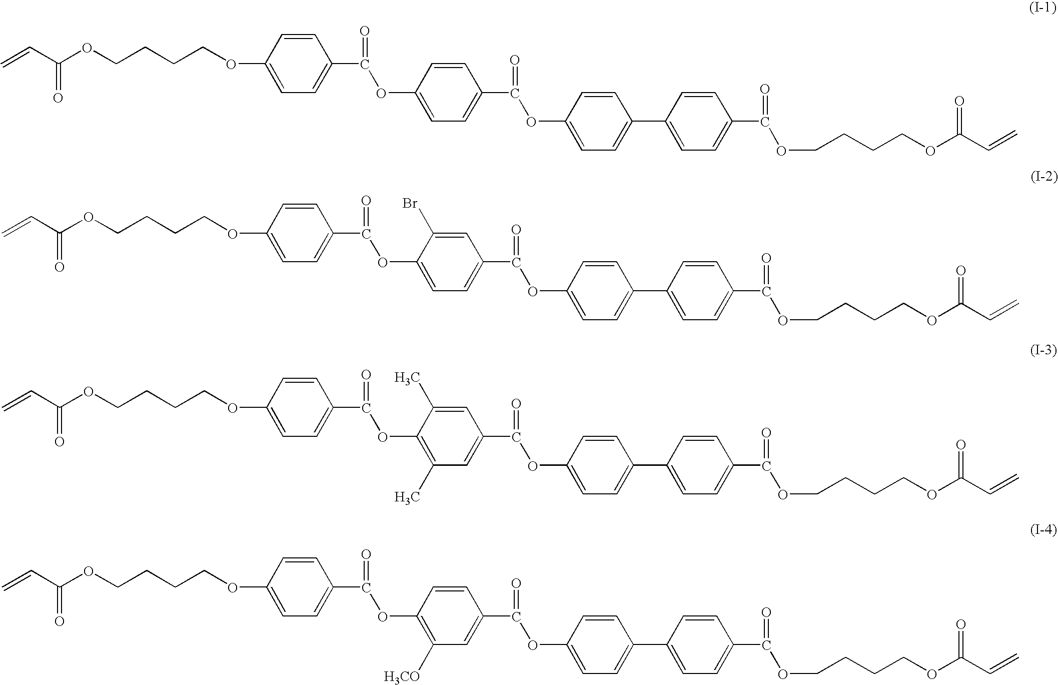

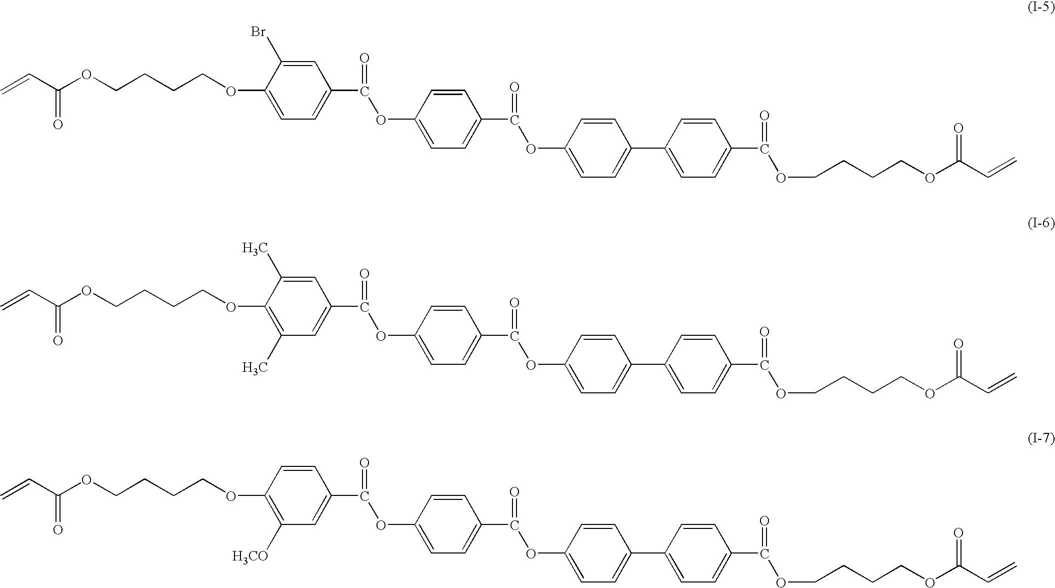

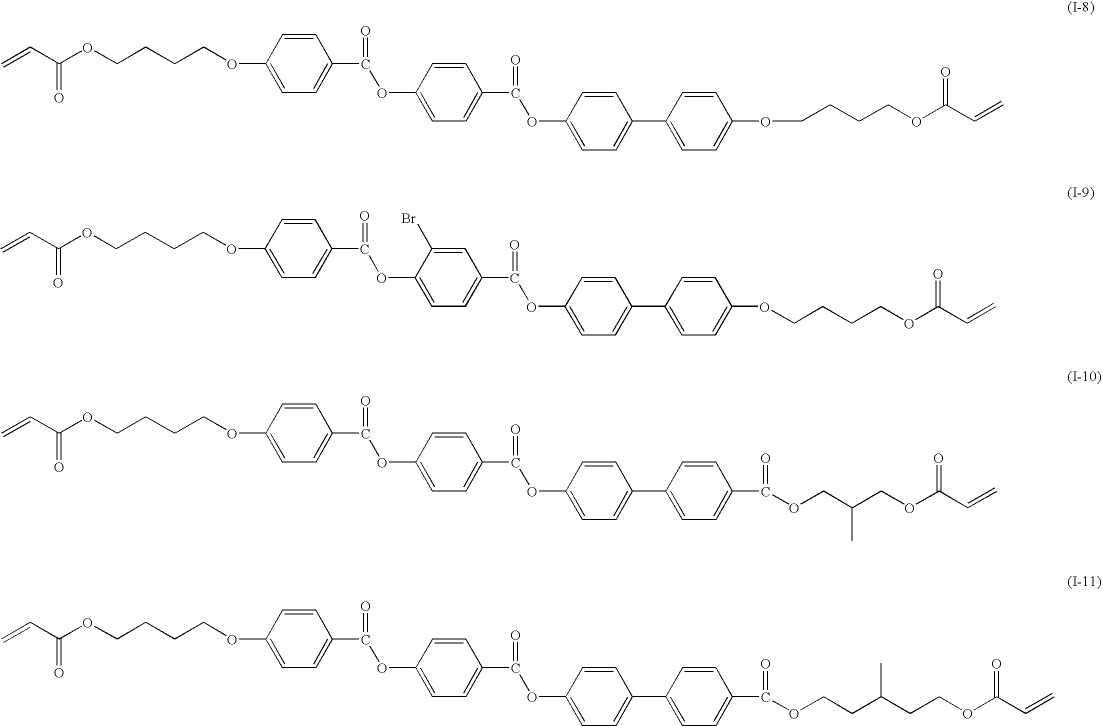

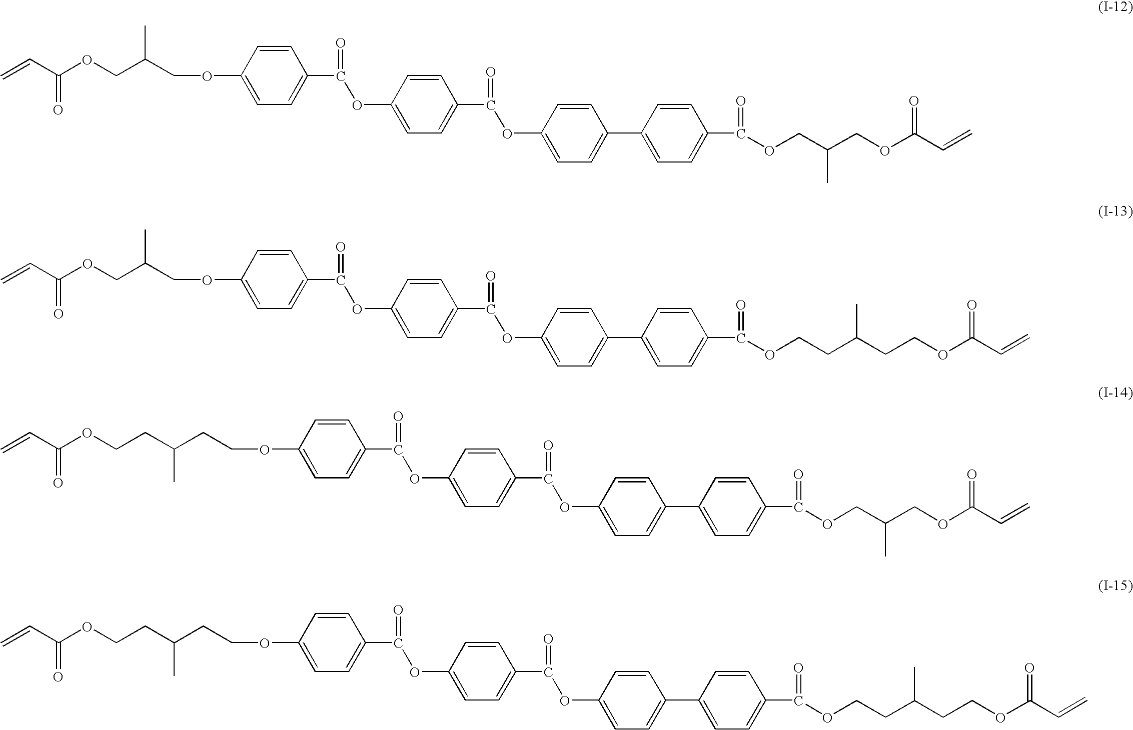

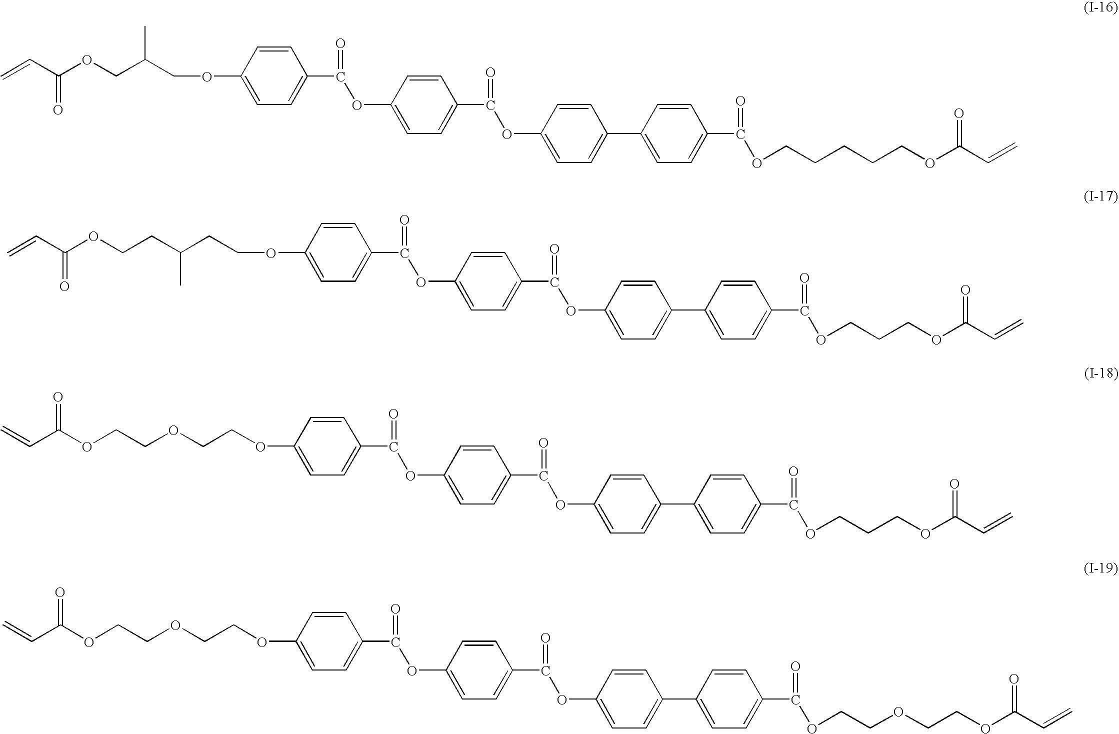

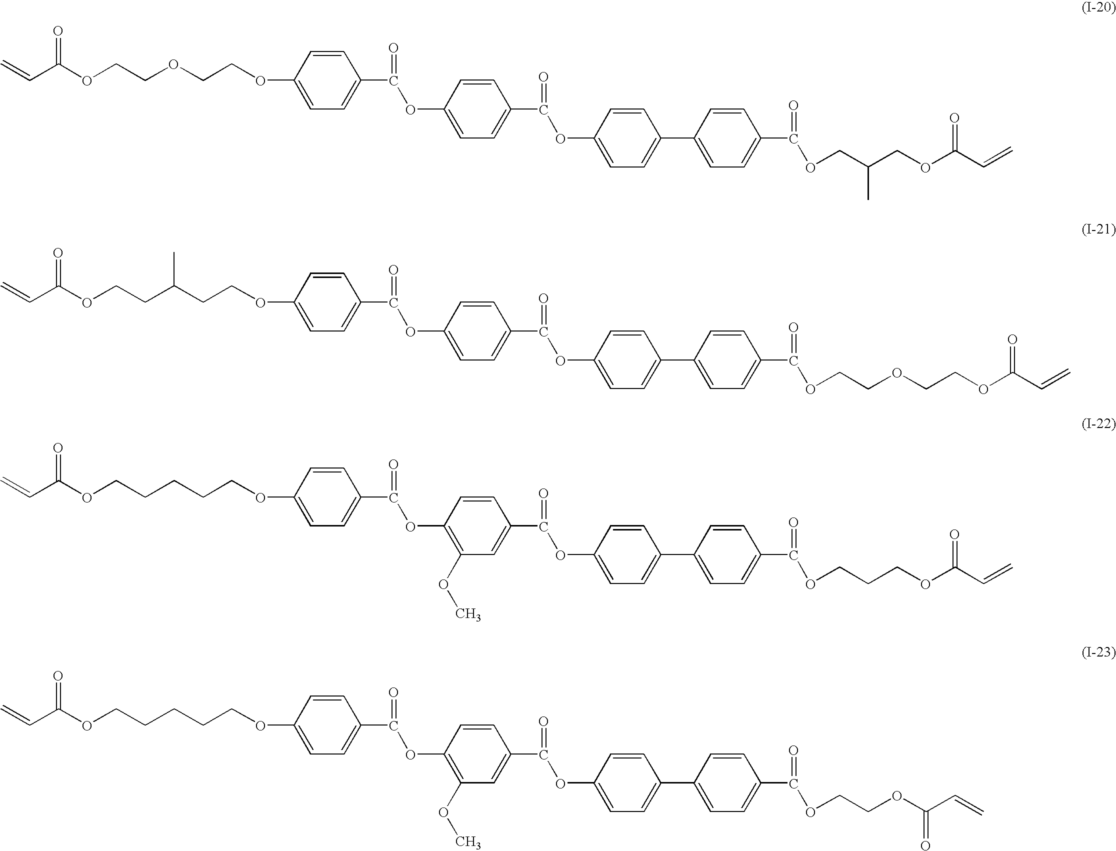

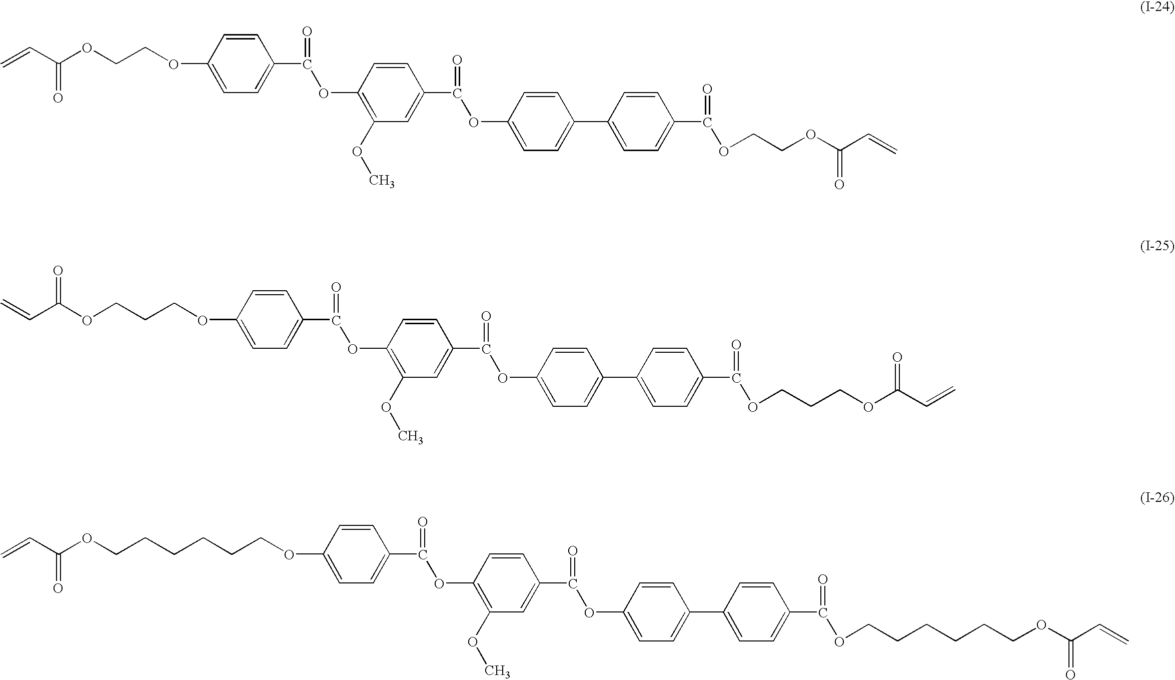

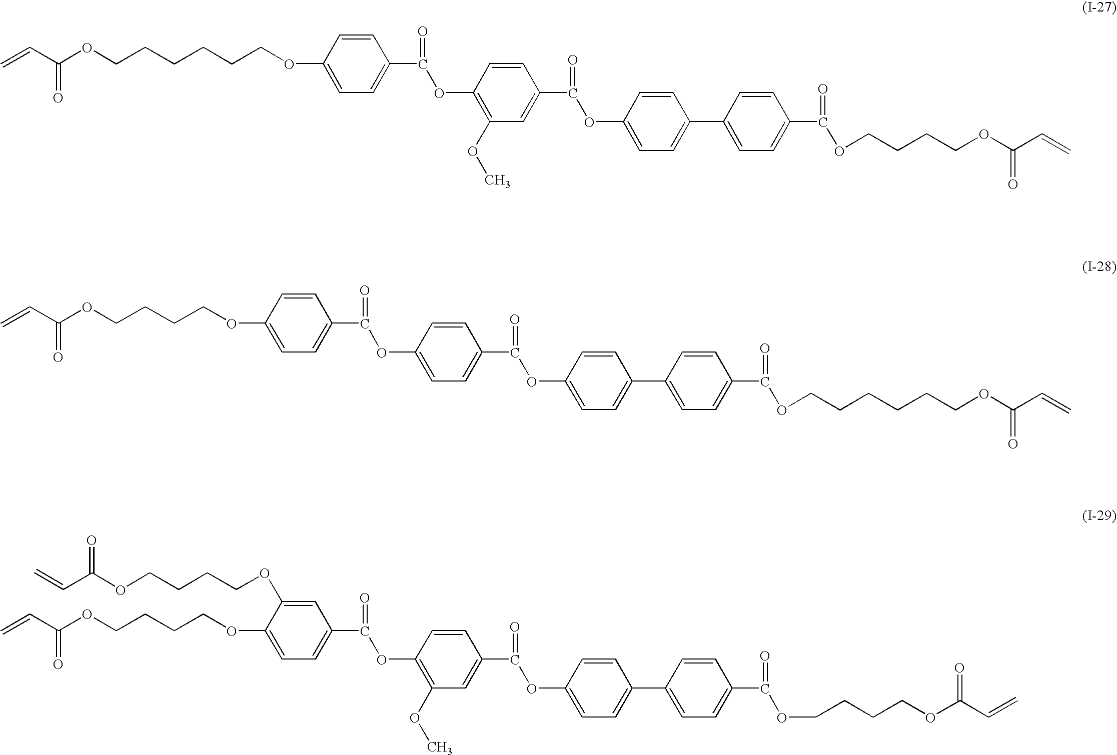

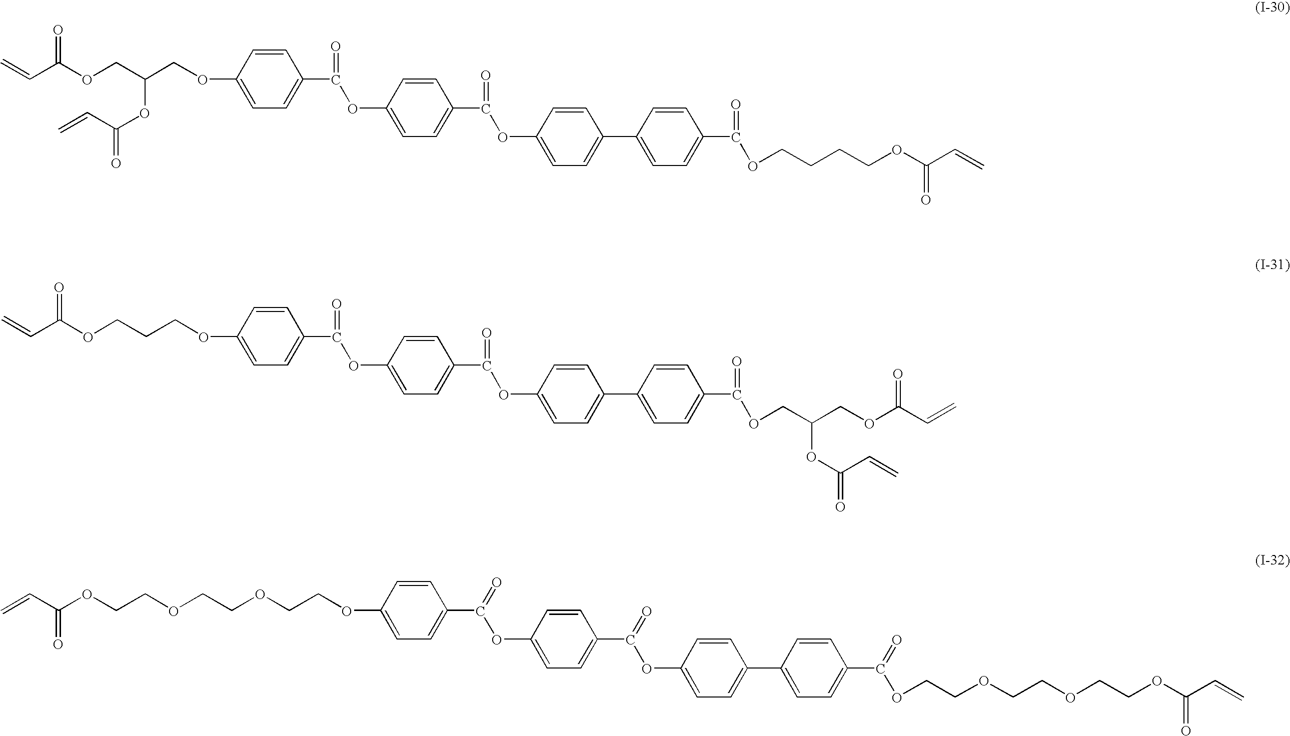

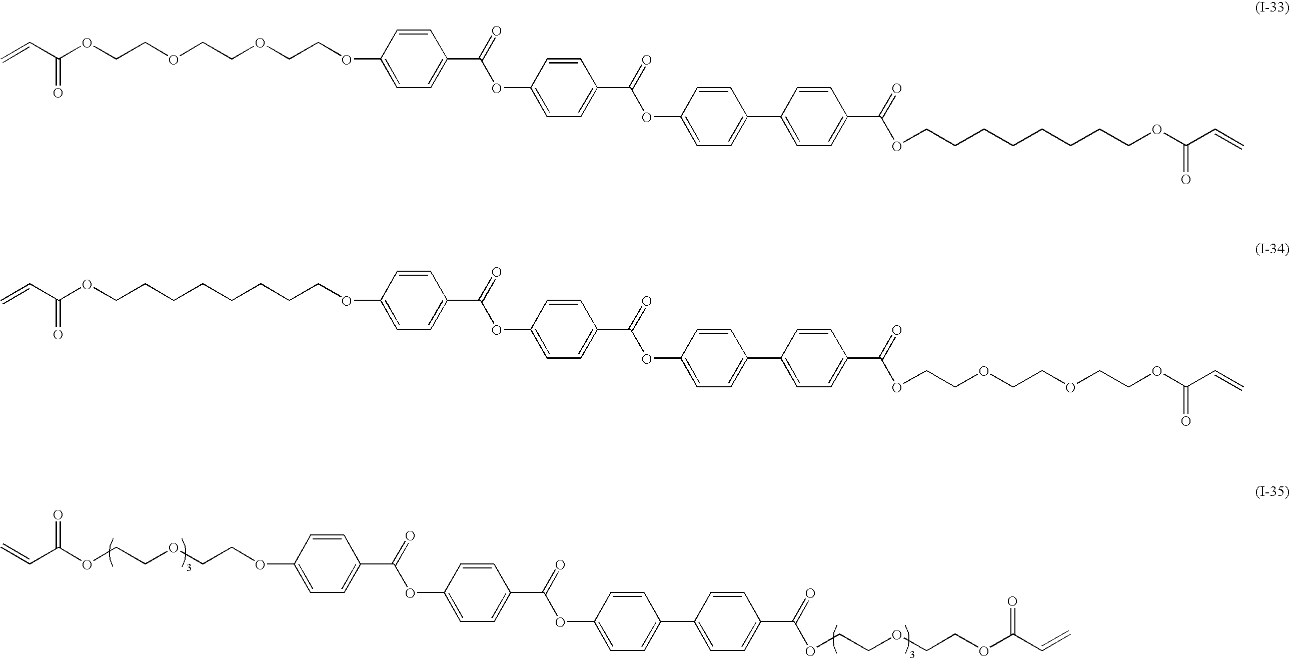

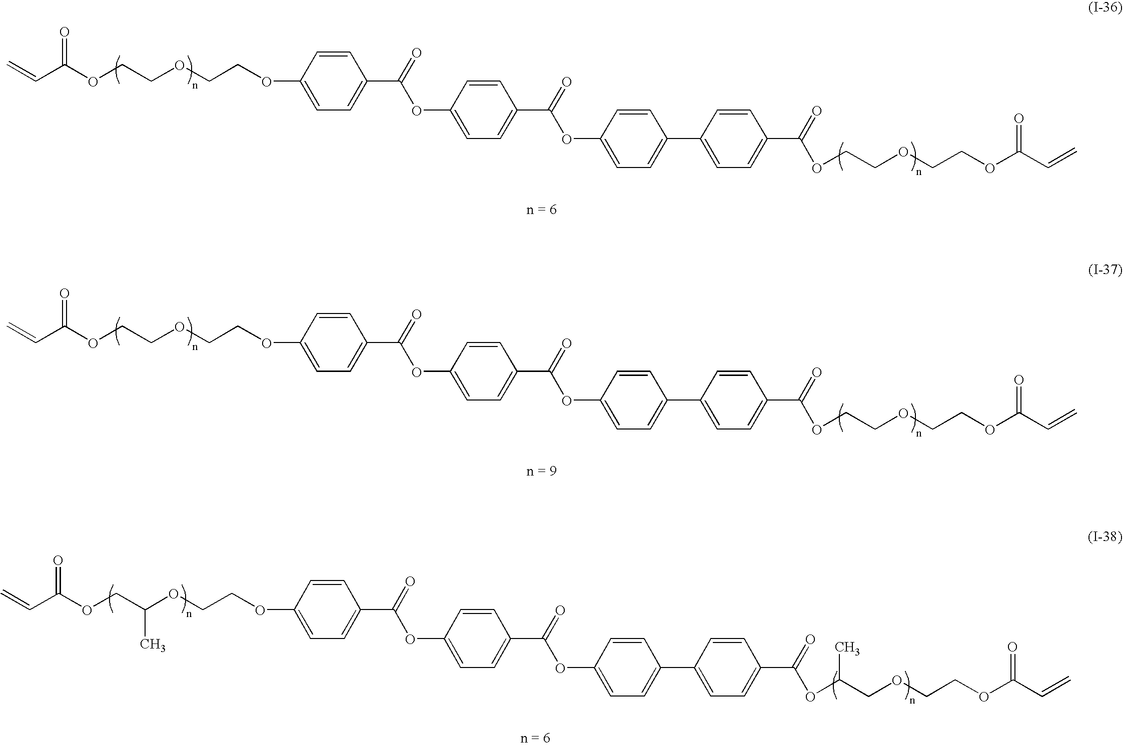

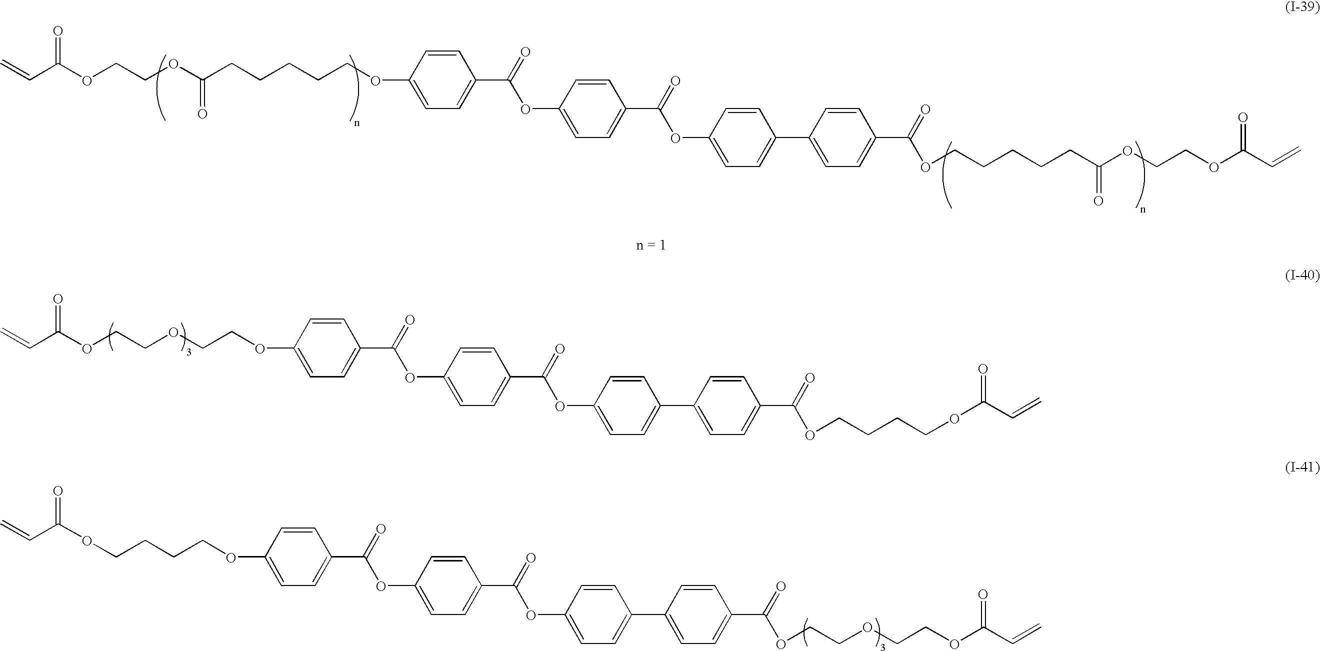

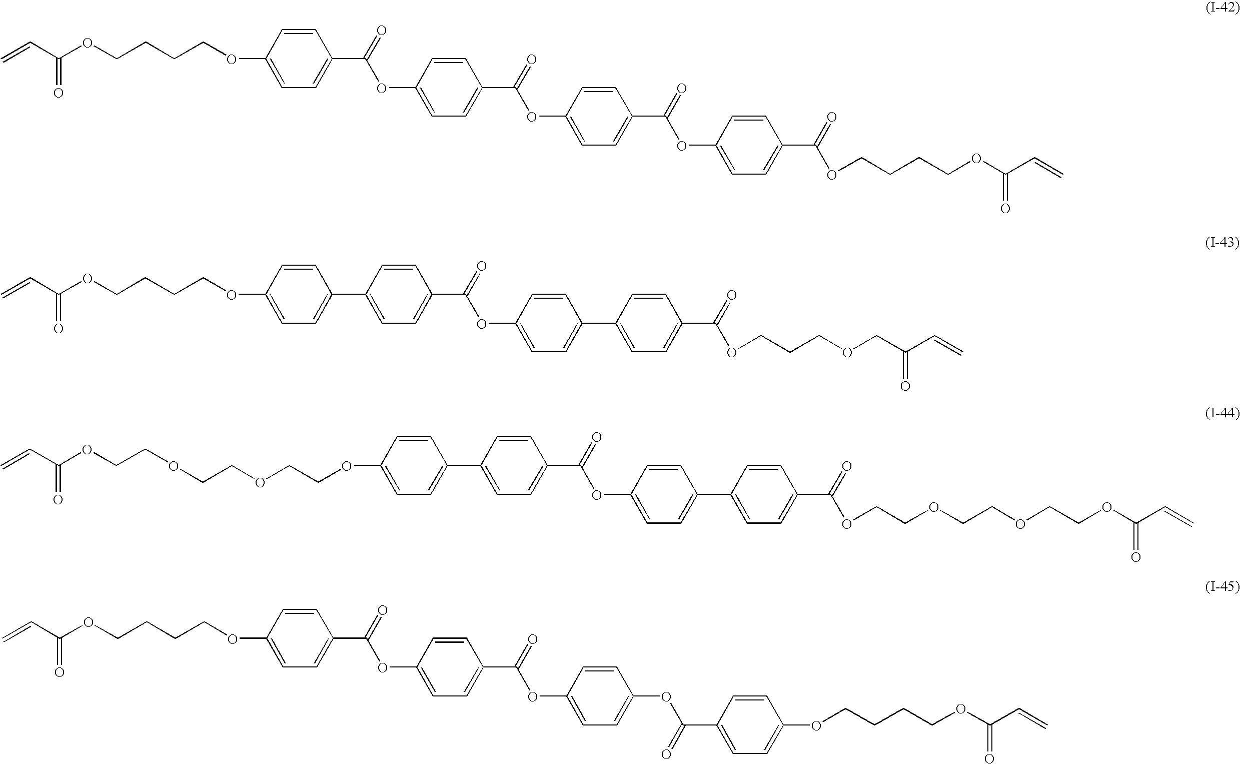

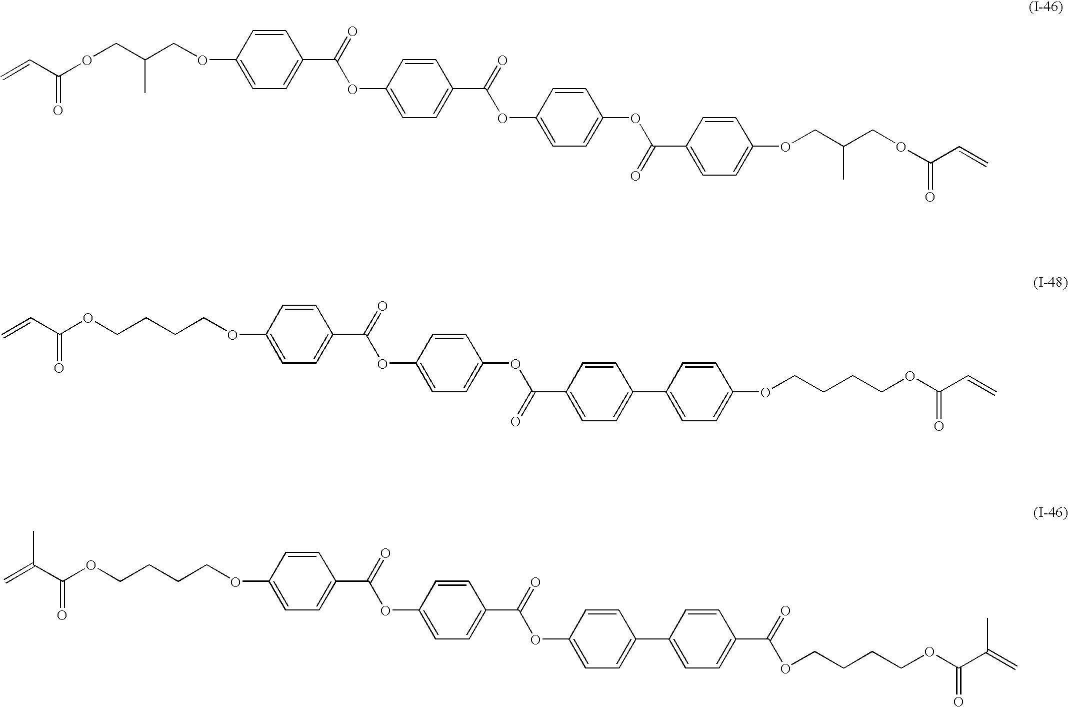

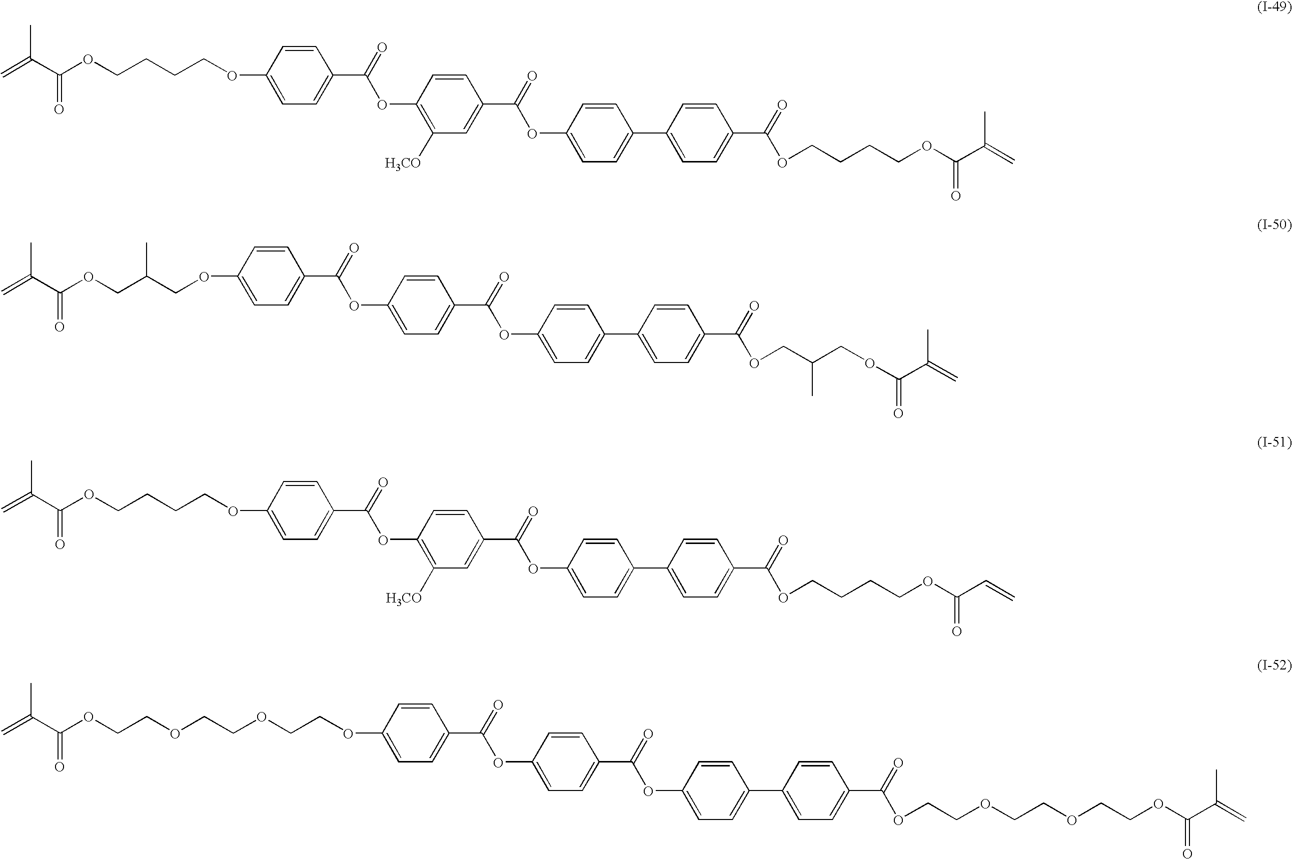

The compound of the invention, represented by the formula (I), can be prepared by combining plural known synthetic reactions. In particular, the compound can be prepared by referring to the methods described in various literatures such as “Methoden derOrganischen Chemie” (edited by Houben-Weyl), “Some specific methods” (published by Thieme-Verlag, written by Stuttgart), “Experiments Chemical Course (Jikken Kagaku Kohza) and “New Experiments Chemical Course (Shin Jikken Kagaku Kohza)”. The contents described in U.S. Pat. Nos. 4,683,327, 4,983,479, 5,622,648, 5,770,107 and WO 95/22586, WO 97/00600, WO 98/47979 and GB Patent No. 2,297,549 may be also referred to for preparing the compound.

The compounds represented by the formula (I) are preferably liquid crystal compounds. In particular, the compounds capable of exhibiting a smectic phase (in the specification, the term “smectic” is used for both of smectic A phase and C phase) alone or under presence of other compounds are more preferable. The compound of the present invention is more preferably any liquid crystal compound capable of exhibiting a smectic phase at a temperature ranging from 80 to 180° C. (more preferably from 70 to 150° C.). Ability of transition to the smectic phase at such a temperature is preferable, because the anisotropic material, making use of anisotropy represented by the smectic phase, can be produced in a stable manner, without excessive heating or excessive cooling.

### [Liquid Crystal Composition]

The liquid crystal composition of the present invention comprises at least one species of the compounds represented by the formula (I). The liquid crystal composition is preferably capable of exhibiting a smectic phase, and is more preferably capable of exhibiting a smectic phase at a temperature ranging from 80 to 180° C., and more preferably from 70 to 150° C. The liquid crystal composition is useful for preparing an anisotropic material such as an optically anisotropic material and an anisotropic electro-conductive material, anisotropy of which being developed by alignment of liquid crystal. In particular, an anisotropic material prepared by curing the liquid crystal composition of the present invention after being aligned in a state of a smectic phase shows anisotropy developed by a highly-ordered smectic phase, so that degradation in the performance due to thermal fluctuation of the liquid crystal phase can be reduced, and thereby a good performance may be expected.

The composition of the present invention may comprise only a single species of the compounds represented by the formula (I), or may comprise two or more species of compounds represented by the formula (I), or may further comprise one or more species of other polymerizable compound (which may be selected from liquid crystalline compounds or non-liquid crystalline compounds). The composition may further comprise a non-polymerizable compound (which may be selected from liquid crystalline compounds or non-liquid crystalline compounds). When the above compound is used with other liquid crystalline compound, the other liquid crystalline compound may be capable of exhibiting a nematic liquid crystal phase, smectic liquid crystal phase, or cholesteric liquid crystal phase; and the liquid crystal composition of the invention, comprising the other liquid crystal compound, (when the composition is in a form of a coating liquid containing a solvent, the composition, that the solvent is vaporized off in a drying step under heating, may be considered), preferably exhibits a smectic liquid crystal phase at a temperature for stabilization of the alignment.

The liquid crystal composition of the present invention preferably comprises one or more types of rod-like liquid crystal compound with the compound represented by the formula (I). In particular, the composition preferably at least one rod-like liquid crystal compound selected from the group consisting of azomethines, azoxy compounds, cyanobiphenyls, cyanophenyl esters, benzoate esters, cyclohexanecarboxyl phenyl esters, cyanophenylcyclohexanes, cyano-substituted phenylpyrimidines, alkoxy-substituted phenylpyrimidines, phenyldioxanes, tolans and alkenyl cyclohexyl benzonitriles. The rod-like liquid crystal compounds whose molecules have a moiety (polymerizable group) capable of polymerization or crosslinking reaction induced by active light ray, electron ray or heat are used preferably. The number of the moiety in a molecule is preferably from 1 to 6, and more preferably 1 to 3. It is also preferable that the compound represented by the formula (I) has two or more polymerizable groups per a molecule; and, so, it is also preferable the rod-like liquid crystal compound has a polymerizable group capable of reacting with the polymerizable group in the compound of the formula (I). Examples of the polymerizable group include radical polymerizable unsaturated group. Specific examples of such a polymerizable group and rod-like liquid crystal compound include polymerizable groups and polymerizable rod-like liquid crystal compounds described in Published Japanese Translation of PCT International Publication for Patent Application No. 2000-514202 and Japanese Laid-Open patent publication “Tokkai” No. 2002-62427.

Using a rod-like liquid crystal compound with the compound represented by the formula (I), the amount of the rod-like liquid crystal compound preferably ranges from 2 to 80 mass % with respect to the total mass of the composition.

### <Additives>

The liquid crystal composition of the present invention may comprise an additive capable of promoting alignment of molecules of the compound represented by the formula (I). The amount of the additive capable of promoting alignment preferably ranges from 0.01 to 10 mass %, more preferably from 0.05 to 5 mass % and much more preferably from 0.05 to 4 mass % with respect to the mass of the compound. The additive capable of promoting alignment may contribute to aligning liquid crystal molecules at an air-interface or an alignment-layer interface with its excluded volume effect or electrostatic effect. The compounds described in Japanese Laid-Open Patent Publication “Tokkai” Nos. 2002-20363 and 2002-129162 may be used. The items described in Japanese Laid-Open Patent Publication “Tokkai” No. 2004-53981, [0072]-[0075], Japanese Laid-Open Patent Publication “Tokkai” No. 2004-4688, [0071]-[0078] and Japanese Laid-Open Patent Publication “Tokkai” No. 2004-139015, [0052]-[0054], [0065]-[0066] and [0092]-[0094] may also be employed.

As the additive capable of promoting vertical alignment of rod-like liquid crystalline compounds, those described in paragraphs [0078] to [0107], [0113] to [0118], [0162] to [0166], and [0189] to [0193] of Japanese Laid-Open Patent Publication “Tokkai” No. 2006-106662 may be employed.

As the additive capable of promoting horizontal alignment of rod-like liquid crystalline compounds, the horizontal alignment agents represented by the formulae (I) to (III) in paragraphs [0058] to [0096] of Japanese Laid-Open Patent Publication “Tokkai” No. 2005-99248, and the additives described in paragraphs [0063] to [0069] of Japanese Laid-Open Patent Publication “Tokkai” No. 2006-126768 may be employed.

These additives capable of promoting the alignment may be used alone, or in combinations of two or more species thereof.

It is to be understood that the term “horizontal alignment” in the context of the present invention means that the direction of long axis of the liquid crystalline compound aligns in parallel with the horizontal plane of the liquid crystal layer (the surface of a support, for an exemplary case where the liquid crystal layer is formed on the support), wherein strict parallelness is not always necessary; and means, in this specification, that a tilt angle of the mean direction of long axes of liquid crystalline molecules with respect to the horizontal plane is smaller than 15° The tilt angle is preferably equal to or smaller than 10°, more preferably equal to or smaller than 5°, still more preferably equal to or smaller than 2°, and most preferably equal to or smaller than 1°. The tilt angle may be 0°, of course.

The amount of the additive capable of promoting the horizontal alignment in the composition is preferably 0.01 to 20% by mass of the liquid crystal compound, more preferably 0.05 to 10% by mass, and still more preferably 0.05 to 5% by mass. The additive capable of promoting the horizontal alignment may be used alone, or in combinations of two or more species.

The liquid crystal composition of the invention may comprise at least one chain-transfer agent. The amount of the chain transfer agent in the composition preferably ranges from 0.01 to 10 mass %, more preferably 0.05 to 5 mass % and much more preferably from 0.05 to 4 mass % with respect to the mass of the compound of the formula (I). Examples of the chain-transfer agent, which can be used in the invention, include compounds having at least one mercapto group such as thiol compounds (e.g. dodecyl mercaptan, octyl mercaptan, trimethyrol propane tris(3-mercapto propionate), penta erythritol tetrakis(3-mercapto propionate) and disulfide compounds (e.g. diphenyl disulfide).

The chin-transfer agent may be required to have compatibility for the liquid crystal compound, and in terms of compatibility, thiol compounds exhibiting liquid crystallinity are more preferable. Examples of the thiol compounds exhibiting liquid crystallinity are described in U.S. Pat. No. 6,096,241.

The composition of the invention may comprise a polymerization initiator, plasticizer, surfactant, polymerizable monomer or polymer additive. Such an additive may be added to the composition for various purposes such as immobilization of an alignment, homogenization of a coating layer, strengthening of a layer and improvement in alignment of liquid crystal molecules. The additives, which are mixable with the liquid crystal compound without disordering the alignment of the liquid crystal compound, are preferable.

Examples of the polymerization initiator, which can be used in the invention, include thermal polymerization initiators and photo-polymerization initiators. Photo-polymerization initiators are more preferable. Examples of the photo-polymerization initiator include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in Japanese Laid-Open Patent Publication “Tokkai” No. S60-105667 and U.S. Pat. No. 4,239,850), and oxadiazole compounds (those described in U.S. Pat. No. 4,212,970).

The amount of the polymerization initiator in the composition is preferably from 0.01 to 20 mass %, and more preferably from 0.5 to 10 mass % with respect to the total mass of the composition (the total mass of the solid content when the composition is a coating fluid).

Examples of the polymerizable monomer, which can be used in the invention, include radical polymerizable monomers and cation polymerizable monomers. Radical polymerizable monomers having two or more polymerizable functions are preferable, and, among those, radical polymerizable monomers capable of copolymerization with the polymerizable liquid crystal compound are more preferable. Examples of the monomer include those described in Japanese Laid-Open Patent Publication “Tokkai” No. 2002-296423, [0018]-[0020]. The amount of the monomer is preferably from 1 to 50 mass %, and more preferably from 1 to 30 mass % with respect to the mass of the compound represented by the formula (I).

Examples of the surfactant, which can be used in the invention, include any known surfactants, and fluorinated compounds are preferable. Examples of the surfactant include those described in Japanese Laid-Open Patent Publication “Tokkai” No. 2001-330725, [0028]-[0056].

The polymer additive may be used for not only promoting the alignment of liquid crystal molecules but also controlling the surface intension or the viscosity of the composition; the polymer additives having any structures can be used so far as they are mixable and dissolved in the composition.

Used for promoting the alignment on liquid crystal molecules, polymers comprising a repeating unit which is capable of aligning them at an air-interface or an alignment-interface with an excluded volume effect or an electrostatic effect, are preferable.

Used for controlling the viscosity of the composition, polymers capable of improving the viscosity are preferable; and examples of such polymer include cellulose esters. Preferable examples of cellulose ester include those described in Japanese Laid-Open Patent Publication “Tokkai” No. 2000-155216, [0178].

Used for controlling the surface tension of the composition, polymers capable of lowering the surface tension are preferable; and examples of such polymer include fluorinated polymers such as known fluorine-containing polymers and surfactants. Among those, polymers comprising a repeating unit derived from a monomer containing a fluorinated aliphatic group are preferable.

The weight-average molecular weight (MW) of the polymer additive preferably ranges from 1,000 to 1,000,000 more preferably from 2,000 to 200,000 and much more preferably from 3,000 to 100,000.

The amount of the polymer additive may be decided so as not to disorder the alignment of liquid crystal molecules, and preferably ranges from 0.01 to 50 mass %, more preferably from 0.05 to 20 mass % and much more preferably from 0.1 to 10 mass % with respect to the mass of the liquid crystal compound.

The composition may be prepared as a coating fluid. An optically anisotropic layer can be prepared readily by applying a coating fluid to a surface of a glass plate, polymer film or the like. Organic solvents are preferably used for preparing the coating fluid. Examples of the organic solvent include amides such as N,N-dimethyl formamide, sulfoxides such as dimethyl sulfoxide, heterocyclic compounds such as pyridine, hydrocarbons such as benzene and hexane, alkyl halides such as chloroform and dichloromethane, esters such as methyl acetate and butyl acetate, ketones such as acetone and methyl ethyl ketone, ethers such as tetrahydrofuran and 1,2-dimethoxy ethane. Among those, alkyl halides, esters and ketones are preferable; and esters and ketones are especially preferable. Two or more types of organic solvents may be used.

### [Anisotropic Material]

The anisotropic material of the present invention is an anisotropic material formed by stabilizing the liquid crystal composition of the present invention. It is preferably formed by stabilizing the liquid crystal composition in a state of a liquid crystal phase, and is more preferably formed by stabilizing the liquid crystal composition in a state of a smectic phase. The anisotropic material of the present invention may, of course, be such as those prepared by stabilizing the liquid crystalline composition in a state of a liquid crystal phase other than a smectic phase, for example to a nematic phase or the like. The composition can be stabilized by carrying out polymerization of the compounds represented by the formula (I) in the composition, or by carrying out polymerization of the compound and optionally-added other polymerizable rod-like liquid crystalline compound and/or polymerizable monomer or the like. An optically anisotropic film can be exemplified as one embodiment of the anisotropic material of the present invention. The optically anisotropic film can be produced by applying the composition containing at least one species of the formula (I) to a surface of an alignment layer to align molecules of the compound in a liquid crystal state, and by stabilizing the alignment state via polymerization.

The optically anisotropic film is preferably formed by applying the composition of the present invention, which is prepared in a coating liquid form, to a surface of an alignment layer or the like, to align molecules of the compound represented by the formula (I) in a state of a liquid crystal phase, more preferably a smectic phase, and then by stabilizing the composition while keeping the alignment state of alignment. The stabilizing can be carried out via polymerization reaction of the compounds of the formula (I). As the polymerization reaction carried out for the stabilizing, photo-polymerization reaction employing a photo-polymerization initiator is preferably used. The irradiation for initiating polymerization of liquid crystalline molecules is preferably carried out with ultraviolet ray. Energy of irradiation preferably ranges from 20 mJ/cm² to 50 J/cm², and more preferably from 100 to 800 mJ/cm². The irradiation may be carried out under heating, in order to accelerate the photo-polymerization reaction.

Thickness of the optically anisotropic film is preferably 0.1 to 10 μm, more preferably 0.2 to 5 μm, and much more preferably 0.5 to 5 μm.

In terms of improvement in uniformity of the alignment, it is preferable that the composition is once aligned to form a nematic phase or an isotropic phase, and then cooled to thereby form a smectic phase. More specifically, it is preferable that the composition is applied to a surface of an alignment film or the like, kept at temperature T₁° C. not lower than the phase transition temperature to the smectic phase so as to form a nematic phase or an isotropic phase, and thereafter cooled below the transition temperature Tₛ to the smectic phase, so as to cause transition to the smectic phase. T₁° C. is preferably (Tₛ+0.1)° C. or above, more preferably (Tₛ+1)° C. or above, and still more preferably (Tₛ+5)° C. to (Tₛ+20)° C. Period during which the temperature is kept at T₁° C. so as to keep the nematic phase or the isotropic phase is preferably 10 seconds or longer, more preferably 20 seconds or longer, and still more preferably from 30 seconds to 3 minutes, both ends inclusive.

An alignment layer may be employed for preparing the optically anisotropic film. The alignment film has a function of predetermining the direction of alignment of the liquid crystalline molecules. The alignment film is used also for the purpose of improving uniformity in the alignment, and still also for the purpose of improving adhesion between the polymer film and the optically anisotropic film, when the optically anisotropic film is formed on the polymer film. Once the state of alignment of the liquid-crystalline compound is fixed after the alignment, the alignment layer may be removed since it already played its role. In other words, only the optically anisotropic film on the alignment film, having a fixed state of alignment, may be transferred onto other supports or polarizers.

The alignment layer that can be employed in the present invention may be provided by rubbing a layer formed of an organic compound (preferably a polymer), oblique vapor deposition, the formation of a layer with microgrooves, or the deposition of organic compounds (for example, omega-tricosanoic acid, dioctadecylmethylammonium chloride, and methyl stearate) by the Langmuir-Blodgett (LB) film method. Further, alignment layers imparted with orientation functions by exposure to an electric or magnetic field or irradiation with light are also known.

The alignment layers formed by rubbing polymer layers are particularly desirable. The polymers used for preparing the alignment layers may basically have a molecular structure capable of aligning liquid-crystalline molecules. According to the present invention, the polymer is desirably selected from polymers having such a molecular structure and further having a structural feature in which a main chain bounds to side chains containing a crosslinkable group (such as a double bonding); or polymers having a structural feature in which a main chain bounds to side chains containing a crosslinkable function group capable of aligning liquid-crystalline molecules. The polymers may be selected from polymers capable crosslinking themselves or polymers to be crosslinked by any crosslinkable agent, and such polymers may be used in any combination.

Examples of the polymer used for preparing an alignment layer include methacrylate copolymers described in the column [0022] in Japanese Laid-Open Patent Publication “Tokkai” No. hei 8-338913, styrene copolymers, polyolefins, polyvinyl alcohols, modified polyvinyl alcohols, poly(N-methylol acrylamide), polyesters, polyimides, vinyl acetate copolymers, carboxymethylcelluloses and polycarbonates. Silane coupling agents are also used as a polymer. Water-solbule polymers such as poly(N-methylol acrylamide), carboxymethylcelluloses, gelatins, polyvinyl alcohols or modified polyvinyl alcohols are preferred; gelatins, polyvinyl alcohols and modified polyvinyl alcohols are more preferred; and polyvinyl alcohols and modified polyvinyl alcohols are much more preferred. Using plural polyvinyl alcohols or modified polyvinyl alcohols, they have a different polymerization degree each other, is especially preferred.

The saponification degree of the polyvinyl alcohol is desirably from 70 to 100%, and more desirably from 80 to 100%. The polymerization degree of the polyvinyl alcohol is desirably from 100 to 5000.

Examples of polyimide, which can be used fro preparing the alignment layer, include “SE-150”, “SE-2170”, “SE-130” and “SE-3140” manufactured by NISSAN CHEMICAL INDUSTRIES LCD.

The polymer may have a side chain capable of aligning liquid crystalline molecules. In usual, such a side chain having a function capable of aligning liquid-crystalline molecules may have a hydrophobic group as a function group. The types of the function group may be decided depending on various factors such as types of the liquid-crystalline compounds or desired alignment state. For example, the modified group can be introduced into the polyvinyl alcohol by copolymerization modification, chain-transfer modification or bloc-polymerization modification. Examples of the modified group include hydrophilic groups such as a carboxylic acid group, a sulfonic acid group, a phosphoric acid group, an amino group, an ammonium group, an amide group or a thiol group; C₁₀₋₁₀₀ hydrocarbon groups; hydrocarbon groups substituted with fluorine atoms; thioether groups, polymerizable groups such as an unsaturated polymerizable group, an epoxy group or an aziridile group; and alkoxysilyl groups such as tri-, di- or mono-alkoxysilyl group. Specific examples of such modified polyvinyl alcohols include those described in the columns [0022] to [0145] in Japanese Laid-Open Patent Publication “Tokkai” No. 2000-155216 and those described in the columns [0018] to [0022] in Japanese Laid-Open Patent Publication “Tokkai” No. 2002-62426.

It is possible to copolymerize a polymer in an alignment layer and a multi-functional monomer in an optically anisotropic layer, when the polymer in the alignment layer has a main chain bonding to side chains containing a crosslinkable functional group, or the polymer in the alignment layer has side chain being capable of aligning liquid-crystalline molecules and containing a crosslinkable functional group. In such case, not only between the multi-functional monomers but also between the polymers in the alignment layer and the multi-functional monomers and the polymers in the alignment layer, the covalent bondings are formed and the bonding strengths are improved. Thus, in such case, the strength of the optical compensatory film can be remarkably improved.

The polymer in the alignment layer desirably has crosslinkable functional group containing a polymerizable group. Specific examples include those described in the columns of [0080] to [0100] in Japanese Laid-Open Patent Publication “Tokkai” No. 2000-155216.

The polymer in the alignment layer may be crosslinked by a crosslinkable agent.

Examples of the crosslinkable agent include aldehydes, N-methylol compounds, dioxane derivatives, compounds to act when being activated their carboxyl groups, active vinyl compounds, active halogen compounds, isoxazoles and dialdehyde starches. Single or plural type of crosslinkable agents may be used. Specific examples of the crosslinkable agent include the compounds described in the columns [0023] to [0024] in Japanese Laid-Open Patent Publication “Tokkai” No. 2002-62426. Aldehydes having a high reaction-activity are preferred, and glutaraldehydes are more preferred.

The amount of the crosslinkable agent is desirable from 0.1 to 20 mass %, and more desirably 0.5 to 15 mass %, with respect to the mass of the polymer. The residual amount of the unreacted crosslinkable-agent in the alignment layer is desirably not greater than 1.0 mass %, and more desirably not greater than 0.5 mass %. When the residual amount falls with in the range, the alignment layer has a sufficient durability, and even if the alignment is used in a liquid-crystal display for a long time, or is left under a high temperature and humidity atmosphere for a long time, no reticulation is appeared in the alignment layer.

The alignment layer may be prepared by applying a coating fluid, containing the above polymer, and, if necessary, the corsslinkable agent, to a surface of a support, drying under heating (crosslinking), and performing a rubbing treatment. The crosslinking reaction may be carried out any time after applying the coating fluid to a surface. When a hydrophilic polymer such as polyvinyl alcohol is used for preparation of an alignment layer, the coating fluid is desirably prepared using a mixed solvent of an organic solvent such as methanol, exhibiting a deforming function, and water. The weight ratio of water to methanol is desirably from 0/100 to 99/1, and more desirably from 0/100 to 91/9. Using such a mixed solvent can prevent bubbles from generating, and can remarkably reduce defects in the surface of the alignment layer and the optically anisotropic layer.

The coating liquid may be applied by any known method such as a spin-coating method, a dip coating method, a curtain coating method, extrusion coating method, rod coating method, or roll coating method. The rod coating method is especially preferred. The thickness of the alignment layer after being dried is desirably from 0.1 to 10 micrometers. Drying may be carried out at 20 to 110° C. In order to form sufficient crosslinking, drying is desirably carried out at 60 to 100° C., and more desirably at 80 to 100° C. The drying may be continued for 1 minute to 36 hours, and desirably for 1 minute to 30 minutes. The pH is desirably set in a proper range for a crosslinkable agent to be used, and when glutaraldehyde is used, the pH is desirably set in a range from 4.5 to 5.5, and more desirably 4.8 to 5.2.

The alignment layer may be formed on a surface of a support such as a polymer film or a surface of an under coating layer which is optionally formed on a support. The alignment layer can be obtained by applying a rubbing treatment to the surface of the polymer layer after crosslinking the polymer layer.

The rubbing treatment may be carried out according to any known treatment used in a liquid-crystal alignment step of LCD. For example, the rubbing treatment may be carried out by rubbing the surface of a polymer layer with a paper, a gauze, a felt, a rubber, a nylon fiber, polyester fiber or the like in a direction. Usually, the rubbing treatment may be carried out by rubbing a polymer layer with a fabric in which fibers having a uniform length and line thickness are implanted averagely at several times.

### [Substrate]

The optically anisotropic film maybe formed on a substrate. The substrate is preferably transparent, and, in particular, preferably has a light transmission of not less than 80%.

The substrate may be selected from polymer films. Examples of materials for the substrate, however not limited to them, include cellulose esters such as cellulose mono, di or tri-acylates, norbornene based polymers and polymethacrylates. Cellulose ester films are preferable; cellulose acetate films are more preferable; and cellulose triacetate films are much more preferable. The polymer films prepared according to a solvent casting method are preferable. The thickness of the substrate is preferably from 20 to 500 μm, and more preferably from 40 to 200 μm. For improving adhesiveness between the substrate and a layer such as an adhesive layer, vertical alignment layer and retardation layer disposed thereon, any surface treatment (e.g. glow discharge treatment, corona discharge treatment, UV irradiation treatment, flame treatment and saponification treatment) may be applied to the surface of the substrate. An adhesion layer (undercoating layer) maybe formed on the substrate. In terms of slipping in a transporting step or preventing surfaces from sticking each other in a rolling-up state, a polymer layer comprising inorganic particles, having a mean particle size of 20 to 100 nm, in a solid-content amount of 5% to 40%, may be formed on a side of the (long) substrate according to a coating method or co-flow casting method.

The anisotropic material of the invention is not limited to embodiments of optically anisotropic films, and the embodiments of the invention include anisotropic conductive materials and anisotropic thermal conductive materials.

### [Applications]

Next, the applications of a film formed of the composition of the invention or a film comprising an optically anisotropic layer formed of the composition of the invention will be explained.

A film prepared by using the composition of the invention can be employed in various applications. The film exhibits a small wavelength-dependency in birefringence and a small humidity-dependency in retardation; and the film is useful in any applications required to have such properties, for example, optical compensation films for LCD and protective films of polarizing plates.

### [Applications (Polarizer Plate)]

The film prepared using the composition of the present invention, in particular the film comprising an optically anisotropic layer formed of the composition on a polymer film (preferably, cellulose film) substrate, is useful as a protective film of a polarizing plate. There is no special limitation on methods of producing a polarizer plate comprising the film as a protective film, and it may be produced according to any general method. One known method is such as subjecting the obtained film to alkali treatment, and bonding it on both surfaces of a polarizer film, which is produced by stretching a polyvinyl alcohol film after being immersed into an iodine solution, using an aqueous solution of a completely saponified polyvinyl alcohol. It is also allowable to adopt, in place of the alkali treatment, adhesion facilitating treatments such as described in Japanese Laid-Open Patent Publication “Tokkai” Nos. H6-94915 and H6-118232.

Examples of the adhesive used for bonding the treated surface of the protective film to the polarizer film include polyvinyl alcohol-base adhesive such as polyvinyl alcohol and polyvinyl butyral; and vinyl-base latex such as butyl acrylate.

The polarizing plate is composed of a polarizer film and protective films protecting both surfaces thereof, or can be configured by bonding a protective film on one surface of the polarizer plate, and by bonding a separation film on the opposite surface. The protective film and the separation film are used for protecting the polarizer plate in the process of shipping thereof, product inspection and so forth. In this case, the protection film is bonded for the purpose of protecting the surface of the polarizer plate, and is provided on the side opposite to the surface to be bonded to the liquid crystal plate. The separate film is used for the purpose of covering the adhesive layer adhered to the liquid crystal plate, and is used on the side of the surface to be bonded to the liquid crystal plate.

The liquid crystal display device generally has a substrate containing a liquid crystal, placed between two polarizing plates, wherein placement of the polarizing plate protective film adopting the above-described film at any positions can ensure excellent display performance. In particular, the polarizing plate protective film composing the topmost surface on the viewing side of the liquid crystal display device is provided with a transparent hard coat layer, anti-glare layer, anti-reflection layer and so forth, so that it is particularly preferable to use the polarizing plate protective film in this portion.

### [Applications (Optical Compensation Film)]

The film prepared by using the composition of the present invention can be used in various applications, and is particularly useful as an optical compensation film of liquid crystal display device. The optical compensation film herein means an optical material generally employed in liquid crystal display devices so as to compensate retardation, and is synonymous with retardation plate, optical compensation sheet and so forth. The optical compensation film has birefringence, and is used for the purpose of eliminating coloration of the display screen of the liquid crystal display device, and of improving the viewing angle characteristics.

### [Liquid Crystal Display Device]

The film (preferably the film comprising an optically anisotropic layer formed of the composition on a cellulose acylate film) intended for use as an optical compensation film allows arrangement of the transmission axis of the polarizer film and the slow axis of the film at any angles. The liquid crystal display device is generally configured by a liquid crystal cell having a liquid crystal held between two electrode substrates, two polarizer films disposed on both sides thereof, and at least one optical compensation film disposed between the liquid crystal cell and the polarizer film. The film made from the composition of the present invention may be incorporated as the optical compensation film, or may be incorporated as a protective film of the polarizer film.

A liquid crystal layer of the liquid crystal cell is generally formed by injecting a liquid crystal into a space formed between two substrates holding spacers in between. A transparent electrode layer is formed on each of the substrates, as a transparent layer containing an electro-conductive substance. The liquid crystal cell can further be provided with a gas barrier layer, a hard coat layer, or an under-coat layer (used for adhering the transparent electrode layer). These layers are generally provided on the substrates. Each of the substrates of the liquid crystal cell preferably has a thickness of 50 μm to 2 mm.

### (Types of LCD)

The film prepared by using the composition of the present invention can be used as optical components (for example, optical compensation film, protective film for polarizer film, etc.) of liquid crystal display devices of various display modes. Specific examples of the display mode include TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned), ECB (electrically controlled birefringence), and HAN (hybrid aligned nematic). The display modes can be used also in a multi-domain display mode. The film can preferably be used also in any of the liquid crystal display devices of transmission type, reflection type and semi-transmission type.

### (TN-Mode Liquid Crystal Display Device)

The film prepared by using the composition of the invention (preferably the film comprising an optically anisotropic layer formed of the composition on a cellulose acylate film) may be used as an optical compensation sheet of TN-mode liquid crystal display device having a TN-mode liquid crystal cell, as a support of a part thereof, or as a protective film for the polarizer plates. The TN-mode liquid crystal cell and the TN-mode liquid crystal display device are well known for a long time. The optical compensation sheet used for the TN-mode liquid crystal display device can be produced according to the description in Japanese Laid-Open Patent Publication “Tokkai” Nos. H3-9325, H6-148429 and H9-26572. The sheet can be produced also according to the descriptions by Mori et al., (Jpn. J. Appl. Phys., Vol. 36 (1997), p. 143, and Jpn. J. Appl. Phys., Vol. 36 (1997), p. 1068).

### (STN-Mode Liquid Crystal Display Device)

The film prepared by using the composition of the invention (preferably the film comprising an optically anisotropic layer formed of the composition on a cellulose acylate film) may be used as an optical compensation sheet of STN-mode liquid crystal display device having an STN-mode liquid crystal cell, as a support of a part thereof, or as a protective film for the polarizer plates. The STN-mode liquid crystal display device generally has rod-like liquid crystalline molecules twisted in the range from 90 to 360° in the liquid crystal cell, wherein the product (Δnd) of the refractive index anisotropy (Δn) of the rod-like liquid crystalline molecules and the cell gap (d) falls in the range from 300 to 1500 nm. The optical compensation sheet used for the STN-mode liquid crystal display device can be produced according to the description in Japanese Laid-Open Patent Publication “Tokkai” No. 2000-105316.

### (VA-Mode Liquid Crystal Display Device)

The film prepared by using the composition of the invention (preferably the film comprising an optically anisotropic layer formed of the composition on a cellulose acylate film) may be used as an optical compensation sheet of VA-mode liquid crystal display device having a VA-mode liquid crystal cell, as a support of a part thereof, or as a protective film for the polarizer plates. The Re value of the optical compensation sheet used for the VA-mode liquid crystal display device is preferably adjusted to 0 to 150 nm, and the Rth value is preferably adjusted to 70 to 400 nm. For the case where two sheets of optically anisotropic polymer film are used for the VA-mode liquid crystal display device, the Rth value of the film is preferably 70 to 250 nm. For the case where a single optically anisotropic polymer film is used for the VA-mode liquid crystal display device, the Rth value of the film is preferably 150 to 400 nm. The VA-mode liquid crystal display device may be of multi-domain system, as described typically in Japanese Laid-Open Patent Publication “Tokkai” No. H10-123576.

### (IPS-Mode Liquid Crystal Display Device and ECB-Mode Liquid Crystal Display Device)

The film prepared by using the composition of the invention (preferably the film comprising an optically anisotropic layer formed of the composition on a cellulose acylate film) may be used as an optical compensation sheet of IPS-mode and ECB-mode liquid crystal display devices respectively having an IPS-mode and ECB-mode liquid crystal cells, as a support of a part thereof, or as a protective film for the polarizer plates. These modes are characterized by near-parallel alignment of the liquid crystal material in the black state, wherein the black state is attained by aligning the liquid crystal molecules in parallel with the substrate surface under no applied voltage. In these modes, the polarizer plate using the film contributes to the improving hue, widening viewing angle, and improving contrast. In these modes, of the protective films of the polarizer plates disposed on the upper and lower sides of the liquid crystal cell, the film made of the composition of the invention is preferably used as a protective film which is disposed between the liquid crystal cell and at least one of the polarizer plates (that is, the protective film on the cell side). It is more preferable to dispose an optically anisotropic layer between the protective film of the polarizer plate and the liquid crystal cell, and to adjust the retardation value of thus-disposed optically anisotropic layer to as large as twice or less of Δn·d of the liquid crystal layer.

### (OCB-Mode Liquid Crystal Display Device and HAN-Mode Liquid Crystal Display Device)

The film prepared by using the composition of the invention (preferably the film comprising an optically anisotropic layer formed of the composition on a cellulose acylate film) may advantageously be used as an optical compensation sheet of OCB-mode and HAN-mode liquid crystal display devices respectively having an OCB-mode and HAN-mode liquid crystal cells, as a support of apart thereof, or as a protective film for the polarizer plates. The optical compensation sheet used for the OCB-mode liquid crystal display device or the HAN-mode liquid crystal display device preferably has no direction showing a minimum absolute value of the retardation value, neither in the in-plane direction nor in the direction of normal line of the optical compensation sheet. Also optical characteristics of the optical compensation sheet used for the OCB-mode liquid crystal display device or the HAN-mode liquid crystal display device are determined depending on the optical characteristics of the optically anisotropic layer, optical characteristics of the support, and arrangement of the optically anisotropic layer and the support. The optical compensation sheet used for the OCB-mode liquid crystal display device or the HAN-mode liquid crystal display device can be produced according to the description in Japanese Laid-Open Patent Publication “Tokkai” No. H9-197397. The sheet can be produced also according to the descriptions by Mori et al., (Jpn. J. Appl. Phys., Vol. 38 (1999), p. 2837).

### (Reflection-Mode Liquid Crystal Display Device)

The film prepared by using the composition of the invention (preferably the film comprising an optically anisotropic layer formed of the composition on a cellulose acylate film) may advantageously be used typically as an optical compensation sheet for reflection-mode liquid crystal display device of TN-mode, STN-mode, HAN-mode and GH (guest-host)-mode. These display modes are well known for a long time. TN-mode reflection liquid crystal display device can be produced according to the descriptions in Japanese Laid-Open Patent Publication “Tokkai” No. H10-123478, International Publication Pamphlet No. WO98/48320, and Japanese Patent Publication No. 3022477. The optical compensation sheet used for the reflection-mode liquid crystal display device can be produced according to the description in International Publication Pamphlet No. WO00/65384.

### (Other Liquid Crystal Display Device)

The film prepared by using the composition of the invention (preferably the film comprising an optically anisotropic layer formed of the composition on a cellulose acylate film) may be advantageously used also as an optical compensation sheet or the like for ASM-mode liquid crystal display device having an ASM (axially symmetric aligned microcell)-mode liquid crystal cell. The ASM-mode liquid crystal cell is characterized in that the thickness of the cell is maintained by position-adjustable resin spacers. Other properties are same as those of the TN-mode liquid crystal cell. The ASM-mode liquid crystal cell and the ASM-mode liquid crystal display device can be produced according to the description in Kume et al., SID 98 Digest 1089 (1998).

### (Hard-Coat Film, Anti-Glare Film and Anti-Reflection Film)

The film prepared by using the composition of the invention (preferably the film comprising an optically anisotropic layer formed of the composition on a cellulose acylate film) may be used as a hard-coat film, anti-glare film or anti-reflection film. For the purpose of improving visibility of flat panel displays such as LCD, PDP, CRT, EL and so forth, any one of, or all of the hard-coat layer, antiglare layer and anti-reflection layer can be provided on one side or both sides of the film. Desirable embodiments as such anti-glare film and anti-reflection film are described in detail in Journal of Technical Disclosure (No. 2001-1745, p. 54-57, issued on Mar. 15, 2001 by JIII), and the above-described films are preferably applicable thereto.

The composition of the present invention is used for producing not only display materials, but also opto-electronics materials and photonics materials, without limited to the above-described applications.

### EXAMPLES

Paragraphs below will further specifically explain features of the present invention referring to Examples and Comparative Examples. Materials, amount of use, ratio, details of processing, procedures of processing and the like shown in Examples below may appropriately be modified without departing from the spirit of the present invention. It is therefore understood that the scope of the present invention should not limitedly be interpreted based on the specific examples shown below.

### [Example of Synthesis of Exemplary Compound (I-1)]

According to the synthetic route shown below, the exemplary compound (I-1) of those represented by the formula (I) was synthesized. Known methods of synthesis were adopted to the individual steps of synthesis. Structures of the products were identified by various spectral data.

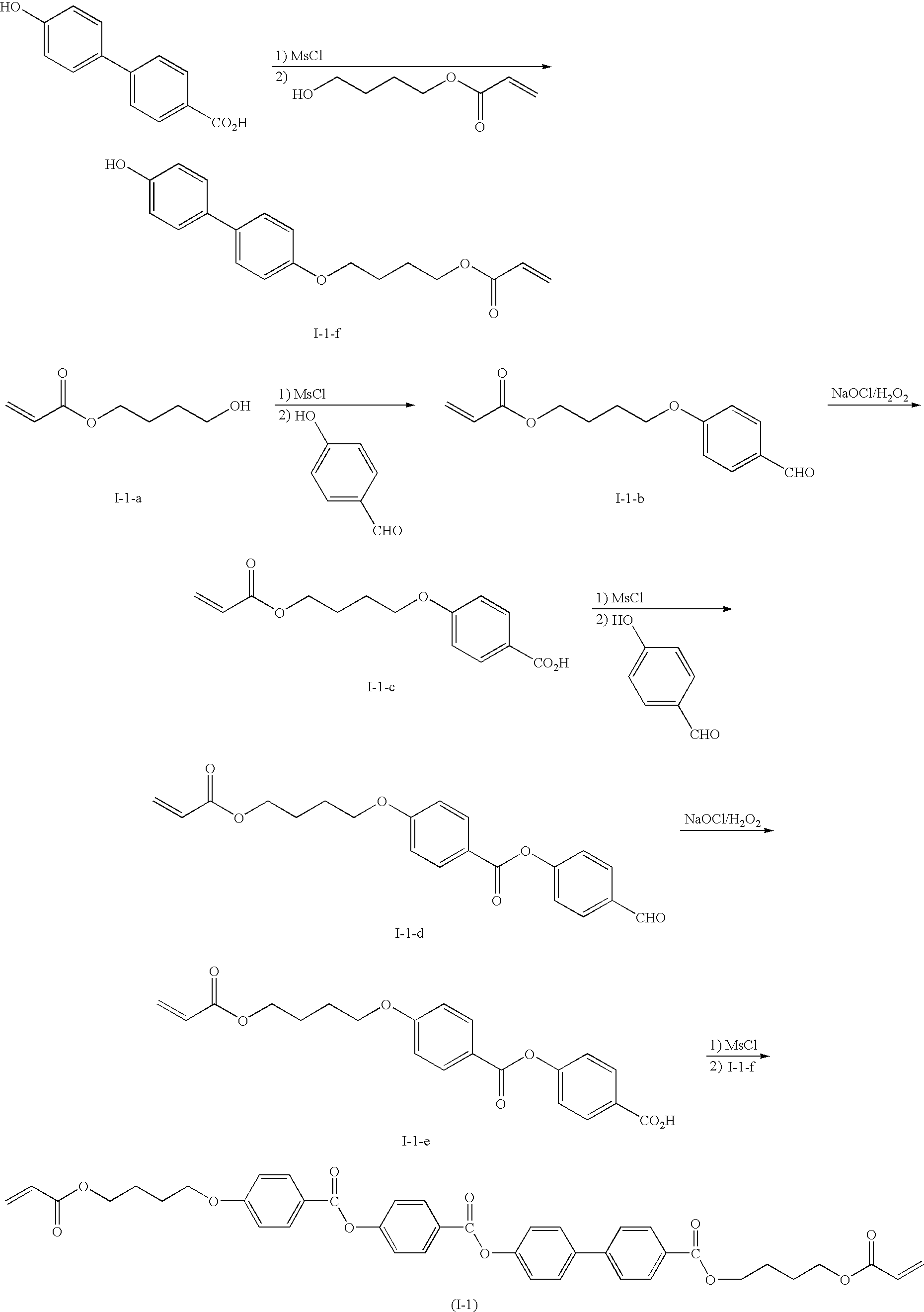

Compound (I-1) was synthesized by using compounds I-1-e and I-1-f synthesized according to the synthetic route shown in the above.

Into 20 mL of tetrahydrofuran, 3.84 g (10 mmol) of I-1-e was dissolved, and 1.14 g (10 mmol) of methanesulfonyl chloride was added dropwise while cooling the mixture to −5° C. or below. Next, 1.68 g (13 mmol) of diisopropylethylamine was added dropwise, and the mixture was stirred at room temperature for 30 minutes. The mixture was again cooled to −5° C. or below, and a 20 mL of a solution of I-1-f dissolved in tetrahydrofuran was added dropwise. The mixture was further added with 122 mg (1 mmol) of 4-dimethylaminopyridine, and stirred at room temperature for 2 hours. The reaction solution was poured into 200 mL of water, and the deposited solid was collected by filtration. The obtained solid was recrystallized from 40 mL of acetonitrile, to obtain 4.95 g of compound (I-1).

Measurement of the melting point and phase transition temperatures of thus-synthesized compound (I-1) revealed a melting point of 89° C., and the phase transition temperature shown below:

Cr→SmC→SmA

### 89° C. 129° C.

The transition temperatures from SmA→N and N→Iso could not be measured, because polymerization took place at 180° C.

Cr represents a crystal phase, SmC represents a smectic C phase, SmA represents a smectic A phase, N represents a nematic phase and Iso represents an isotropic phase.

Exemplary compounds represented by the formula (I) were synthesized similarly to as described in the above, and melting point and phase transition temperatures of the individual compounds were measured. Results are shown in Table 1.

TABLE 1

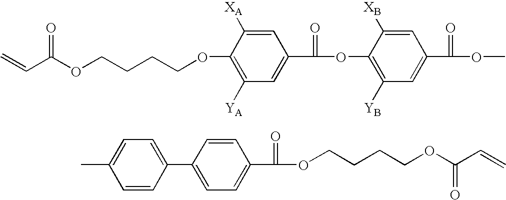

| | A-ring | | Bring | | | | | |
|---|---|---|---|---|---|---|---|---|
| | X | Y | X | Y | mp.(ΔH mJ/mg)) | SmC-SmA | SmA-N | N-iso |
| I-1 | H | H | H | H | 89 | 129 | >180 | >180 |
| I-2 | H | H | Br | H | 91 | — | 156 | >180 |
| I-3 | H | H | Me | Me | 81 | — | (63) | 160 |
| I-4 | H | H | MeO | H | 60 | | 130 | 190 |
| I-5 | Br | H | H | H | 90 | 145 | >200 | >200 |
| I-6 | Me | Me | H | H | 96 | (79) | 156 | 190 |
| I-7 | MeO | H | H | H | 86 | 110 | 167 | >200 |

As an example, the exemplary syntheses of the compound having —SP¹—X¹— and —X²—SP²— of the formula (I) represented by the formula (SP-1a) or (SP-1b) are described above. However, any compounds having —SP¹—X¹— and —X²—SP²— represented by the formula (SP-2a) or (SP-2b) can be synthesized, for example by replacing hydroxybutyl acrylate used in the above-described synthetic route with acrylates A shown below (in the formula below, X represents a halogen atom (preferably a chlorine atom or bromine atom) or OH). Acrylates A below can readily be synthesized from acrylic acid or acrylic acid chloride, and commercially-available alcohols B represented by the formula below (in the formula below, X represents a halogen atom (preferably a chlorine atom or bromine atom) or OH). In the formula below, m represents an integer, preferably an integer from 1 to 10, and more preferably an integer from 1 to 6.

### Acrylates A

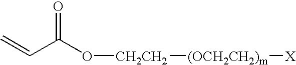

### Alcohols B

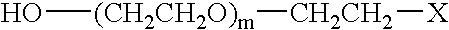

As an example, the exemplary syntheses of the compounds having -A-B—C-D- represented by the formula below:

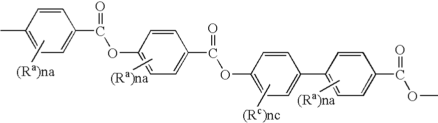

are described above. However, the compounds having -A-B—C-D- represented by other formulae can also be synthesized by repeating similar reactions.

For example, an exemplary compound I-8 having -A-B—C-D- represented by the formula below can be synthesized by a synthetic route shown below.

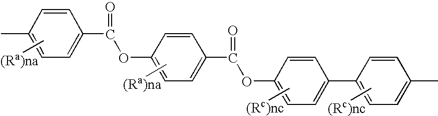

### Example of Synthesis of Exemplary Compound (I-8)

Exemplary compound (I-8) can be synthesized using an intermediate (I-1-e) of compound (I-1), according to the synthetic route shown below.

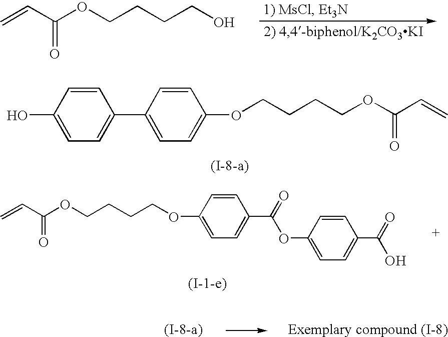

Exemplary compound (I-42) having -A-B—C-D- represented by the formula below can be synthesized by the synthetic route shown below.

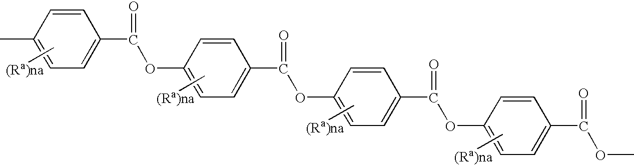

### Example of Synthesis of Exemplary Compound (I-42)

Exemplary compound (I-42) can be synthesized using an intermediate (I-1-e) of compound (I-1), according to the synthetic route shown below.

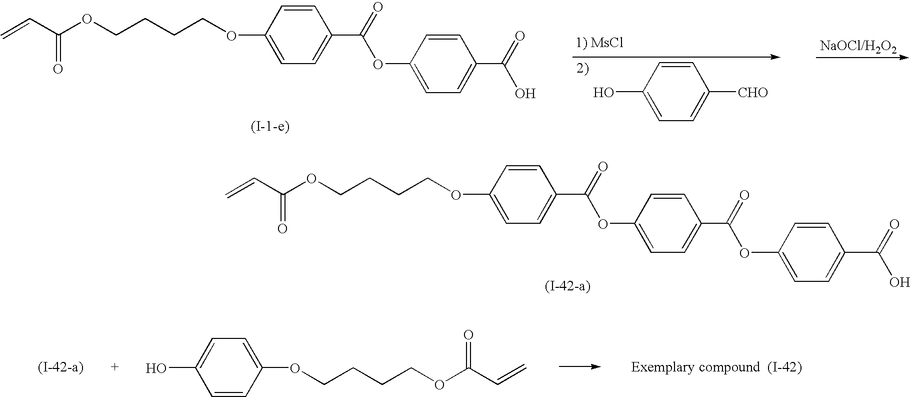

The compounds shown in the above may exhibit a transition into a smectic phase as well as compounds I-1 to 7 obtained by the exemplary syntheses, because they have the same order of arrangement of atoms in a plurality of ester bonds.

### Example of Synthesis of Exemplary Compound (I-47)

Exemplary compound (I-47) represented by the formula (I) was synthesized according to the synthetic route shown below. The individual steps of synthesis were conforming to known methods of synthesis.

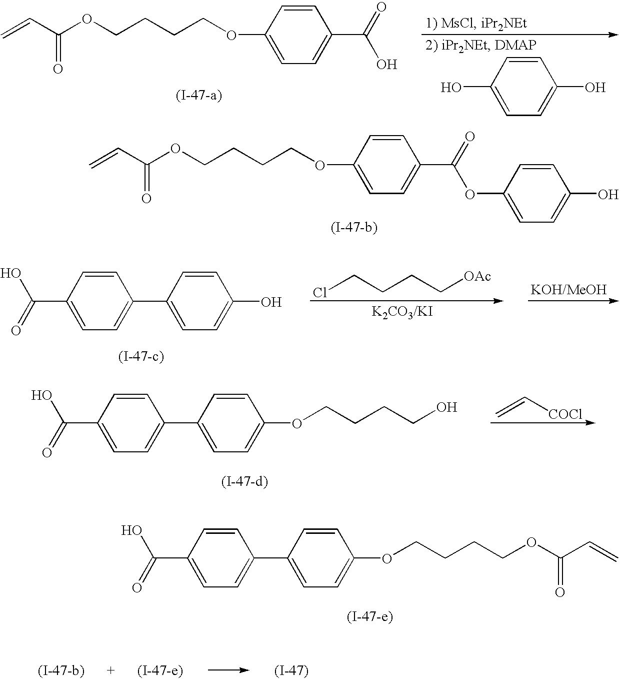

First, compounds I-47-b and I-47-e were synthesized respectively according to the synthetic route described in the above. Next, 3.40 g (10 mmol) of I-47-e was dissolved in 20 mL of tetrahydrofuran, and 1.14 g (10 mmol) of methanesulfonyl chloride was added dropwise, while cooling the mixture to −5° C. or below. Next, 1.68 g (13 mmol) of diisopropylethylamine was added dropwise, and the mixture was stirred at room temperature for 30 minutes. The mixture was again cooled to −5° C. or below, and 20 mL of tetrahydrofuran solution containing 3.56 g (10 mmol) of I-47-b dissolved therein was added dropwise. The mixture was further added with 122 mg (1 mmol) of 4-dimethylaminopyridine, and stirred at room temperature for 2 hours. The reaction solution was poured into 200 mL of water, and the deposited solid was collected by filtration. The obtained solid was purified by silica gel column chromatography, and further recrystallized from acetonitrile, to obtain 2.0 g of compound (I-47).

Various compounds having -A-B—C-D- represented by the formula below can be synthesized, similarly to as compound I-47.

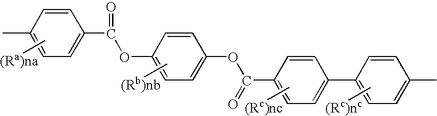

### Example 2

### <Preparation of Alignment Film>

To a surface of a cleaned glass substrate, a coating liquid for alignment film having the formulation below was applied using a wire bar coater to an amount of 20 mL/m². The coating layer was dried under a hot air of 60° C. for 60 seconds, and further under a hot air of 100° C. for 120 seconds, to thereby obtain an alignment film.

Formulation of Alignment Film

| | |
|---|---|
| Modified polyvinyl alcohol, below | 10 parts by mass |
| Water | 371 parts by mass |
| Methanol | 119 parts by mass |
| Glutaraldehyde | 0.5 parts by mass |

Modified Polyvinyl Alcohol

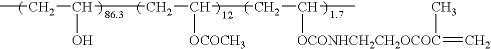

### <Preparation of Optically Anisotropic Film>

Next, 3.8 g of exemplary compound (I-2) represented by the formula (I), 152 mg of a photo-polymerization initiator (Irgacure 819, from Ciba Specialty Chemicals K.K.), 76 mg of additive 1 having the structure below, and 15 mg of additive 2 having a structure below were dissolved into 16.4 g of 1,1,2-trichloroethane, to thereby prepare a coating liquid. The coating liquid was then coated on the alignment film by spin coating, and observed under a polarization microscope under heating. The phase transition temperature from the smectic A phase to nematic phase was found to be 135° C., whereas the phase transition temperature from the nematic phase to isotropic phase could not be measured due to polymerization of compound I-2.

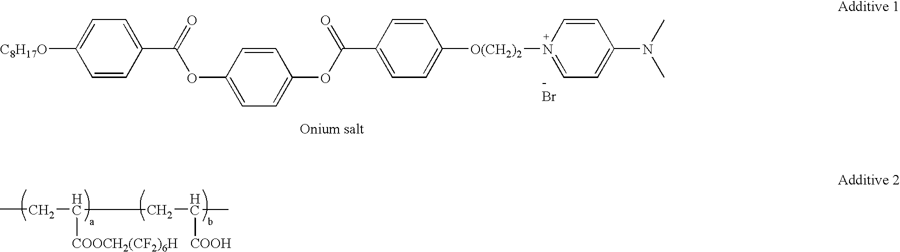

The coating liquid was coated on the alignment film by spin coating. The coating was heated at 150° C. for 1 minute, and then cooled to 125° C. at a cooling rate of 5° C./minute, so as to proceed alignment. The coating, while being kept at 125° C., was cured under UV irradiation using a high-pressure mercury lamp at an irradiation energy of 50 mW/cm² for 15 seconds so as to fix the molecules in the alignment state, and the film was then allowed to stand for cooling to room temperature, to thereby form an optically anisotropic film. The obtained optically anisotropic film was found to be 1.1 μm thick.

Observation under the polarization microscope showed that film remained in complete dark field even if rotated on a rotating stage. The front view showed almost no optical anisotropy. Measurement of incident angle dependence of Re of the manufactured film, using an automatic birefringence analyzer (KOBRA-21ADH, from Oji Scientific Instruments), revealed that the front view showed Re of almost zero, whereas retardation measured at 40° was found to be 40 nm at 589 nm, and retardation measured at −40° was found to be 41 nm at 589 nm. The film was therefore found to be an optically anisotropic film having the slow axis in the vertical direction.

### Example 3

An alignment film was formed on a glass substrate according to the method described in Example 2, and rubbed.

Next, 3.8 g of exemplary compound (I-2) represented by the formula (I), 152 mg of a photo-polymerization initiator (Irgacure 819, from Ciba Specialty Chemicals K.K.), and 15 mg of additive 3 having the structure below were dissolved into 16.4 g of 1,1,2-trichloroethane, to thereby prepare a coating liquid. The coating liquid was then coated on a slide glass, and observed under a polarization microscope under heating. The phase transition temperature from the smectic A phase to nematic phase was found to be 135° C., whereas the phase transition temperature from the nematic phase to isotropic phase could not be measured due to polymerization of compound I-2.

The coating liquid was coated on the alignment film by spin coating. The coating was heated at 150° C. for 1 minute, and then cooled to 125° C. at a cooling rate of 5° C./minute, so as to proceed alignment. The coating, while being kept at 125° C., was cured under UV irradiation using a high-pressure mercury lamp at an irradiation energy of 50 mW/cm² for 15 seconds so as to fix the molecules to the state of alignment, and the film was then allowed to stand for cooling to room temperature, to thereby form an optically anisotropic film. The obtained optically anisotropic film was found to be 1.1 μm thick.

Observation under the polarization microscope showed that the obtained film has almost no defect and has a uniform alignment. The obtained optically anisotropic film was found to have the slow axis along with the direction of rubbing applied to the alignment film, and retardation measured by Senalmont technique was 200 nm at 546 nm. Retardation of the optically anisotropic film was also measured under heating at 50° C. similarly by Senalmont technique, only to find no changes in the retardation.

Measurement of incident angle dependence of Re of the manufactured film, using an automatic birefringence analyzer (KOBRA-21ADH, from Oji Scientific Instruments), revealed that a quotient Re(448.5)/Re(749.1), obtained by dividing Re measured at 448.5 nm with Re measured at 749.1 nm, was found to be 1.31.

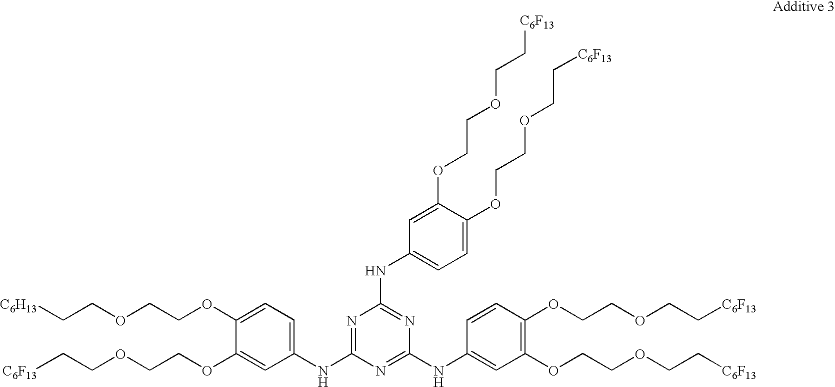

### Comparative Example 1

An optically anisotropic film was produced similarly to as described in Example 3, except that an equi-weight mixture of compound (e) and compound (f) below was used in place of the liquid-crystalline compound.

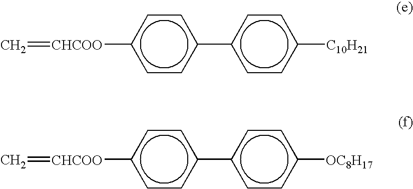

Compound described in Japanese Laid-Open Patent Publication No. H8-283718

The obtained optically anisotropic film was found to be 1.0 μm thick, and retardation measured by Senalmont technique was found to be 110 nm at 546 nm. Retardation of the optically anisotropic film under heating at 50° C. measured similarly by Senalmont technique was found to change to 83 nm at 546 nm.

The optically anisotropic film of Example 3 showed, as described previously, no change in retardation by heating at 50° C.

### Comparative Example 2

An optically anisotropic film was manufactured similarly to as described in Example 3, except that compound (g) below was used in place of the liquid-crystalline compound.

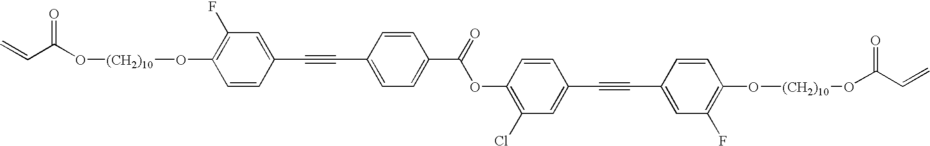

### Compound described in Japanese Laid-Open Patent Publication No. 2005-16406

The obtained optically anisotropic film was found to be 1.0 μm thick, and retardation measured by Senalmont technique was found to be 240 nm at 546 nm.

Measurement of wavelength dependence of Re of the manufactured film using the automatic birefringence analyzer (KOBRA-21ADH, from Oji Scientific Instruments) revealed that a quotient (Re(448.5)/Re(749.1)), obtained by dividing Re measured at 448.5 nm with Re measured at 749.1 nm, was found to be 1.72. As described in the above, Re(448.5)/Re(749.1) of the optically anisotropic film in Example 3 was 1.31, proving that smaller wavelength-dispersion of Re was shown by the optically anisotropic film of Example 3.

### Example 4

### <Preparation of Alignment Film>

To a surface of a cleaned glass substrate, a dilute solution of SE-150 from Nissan Chemical Industries, Ltd. was successively coated, dried under hot air of 80° C. for 5 minutes, and further dried under hot air of 250° C. for 60 minutes, sintered, and the obtained alignment film was then rubbed.

### <Preparation of Optically Anisotropic Film>

Three grams of exemplary compound (I-32) represented by (1), 60mg of a photo-polymerization initiator (Irgacure 819, from Ciba Specialty Chemicals K.K.) and 6 mg of the above-described additive 3 were dissolved into 18.8 mL of chloroform, to thereby prepare a coating liquid. The coating liquid was applied to the surface of a slide glass, and the coating layer was observed under heating under a polarization microscope. Phase transition temperature from the smectic A phase to nematic phase was found to be 148° C.

The coating liquid was applied to the surface of the alignment film by spin coating. The coating was dried at 155° C. for 1 minute, then cooled to 120° C. at a cooling rate of 5° C./minute, so as to proceed alignment. The atmosphere, kept at 120° C., was substituted by nitrogen with the oxygen concentration adjusted to 0.5%, and the coating was irradiated by UV using a high-pressure mercury lamp, at an irradiation energy of 100 mW/cm² for 10 seconds for curing, the molecules of which were fixed to the state of alignment, and the resultant film was then allowed to cool to room temperature, to thereby form an optically anisotropic film. The obtained optically anisotropic film was found to be 1.31 μm thick.

Observation under the polarization microscope showed that the obtained film has almost no defect and has a uniform alignment. The obtained optically anisotropic film was found to have the slow axis along the direction of rubbing effected thereto. Retardation of thus manufactured film measured using an automatic birefringence analyzer (KOBRA-21ADH, from Oji Scientific Instruments) was found to be 148 nm at 546 nm, with an angle of inclination of 1°.

### Example 5

### IPS Mode Liquid Crystal Display Device

An IPS mode liquid crystal display device was produced referring to Example 9 described in paragraphs [0284] to [0308] of Japanese Laid-Open Patent Publication “Tokkai” No. 2006-106662. Exceptionally, a retardation film 1-2A was produced by forming a second retardation film according to the method below, employed in the place of the method of producing a second retardation film 102 described in paragraphs [0292] to [0297] of this publication.

In particular, a first retardation film 1-2, which was produced according to the method described in Japanese Laid-Open Patent Publication “Tokkai” No. 2006-106662, was saponified on the surface thereof, and to the saponified surface of this film, the coating liquid for forming alignment film used above in Example 2 was applied and dried, to thereby form a polymer film. Thus formed polymer film was subjected to a rubbing treatment in the direction parallel to the direction of slow axis of the film, to thereby obtain an alignment film.

Next, 3.8 g of compound (I-4) of the present invention, 152 mg of a photo-polymerization initiator (Irgacure 819, from Ciba Specialty Chemicals K.K.), and 76 mg of additive 1 and 15 mg of additive 2 having the structure shown below were dissolved into 16.5 g of 1,1,2-trichloroethane, to thereby prepare a coating liquid. The coating liquid was then applied to the rubbed surface of the alignment layer formed on the film, heated at 135° C. for 1 minute, and then cooled to 110° C. at a cooling rate of 5° C./minute, so as to proceed alignment. After adjusting the oxygen concentration of the atmosphere to 1% or below, the coating, while being kept at 125° C., was cured under UV irradiation using a high-pressure mercury lamp at an irradiation energy of 50 mW/cm² for 15 seconds so as to fix the molecules in the alignment state, and the film was then allowed to stand for cooling to room temperature so as to form an optically anisotropic film, to thereby obtain the retardation film 1-2A having the second retardation film formed on the first retardation film.

A liquid crystal display device was then manufactured similarly to as described in the Laid-Open patent publication, except only that the retardation film 1-2A was used in the place of the retardation film 1-2.

Thus produced liquid crystal device was observed in a left oblique direction with an inclination angle of 60°, so as to measure leakage of light.

Method of measuring leakage of light was same as that described in paragraph [0308] of Japanese Laid-Open Patent Publication No. 2006-106662.

### Comparative Example 3

A liquid crystal display device was produced as described in Example 9 in paragraphs [0284] to [0308] of Japanese Laid-Open Patent Publication “Tokkai” No. 2006-106662, and similarly, leakage light observable in a left direction with an indication angle of 60° was measured.

Results of the measurement of leakage light in Example 5 and Comparative Example 3 are shown in Table 1 below. Form the results shown in Table 1, it is understandable that the IPS mode liquid crystal cell was optically compensated in an exact manner by employing an optically anisotropic film prepared using the compound of the present invention, and thereby the liquid crystal display device causative of only a small degree of light leakage in oblique directions could be provided.

TABLE 1

| | | Second | | |
|---|---|---|---|---|
| Polarizer | | retardation | Leakage | |
| plate | Film No. | region 1 | light | |
| Polarizer | Retardation | Second | 0.10% | Comparative |
| plate 1-2 | film 1-2*¹ | retardation | | Example 3 |
| | | region 1-2 | | |
| Polarizer | Retardation | Second | 0.08% | Example 5 |
| plate 1-2 | film 1-2A | retardation | | |
| | | region 1-2 | | |

*¹Retardation film 1-2 produced according to the method described in Example 9, paragraphs [0292] to [0297] of Japanese Laid-Open Patent Publication “Tokkai” No. 2006-106662.

### Example 6

### VA Mode Liquid Crystal Display Device

Referring to Example 2 described in paragraphs [0199] to [0222] of Japanese Laid-Open Patent Publication No. 2006-126768, a VA mode liquid crystal display device was produced. Exception was that an integrated-mode upper polarizer plate was manufactured according to a method described below, rather than according to the method described in paragraphs [0201] to [0214] of the publication.

In particular, a transparent support A was manufactured according to the method described in Japanese Laid-Open Patent Publication “Tokkai” No. 2006-126768, then the coating liquid for forming alignment film used above in Example 2 was similarly applied to one surface of thus-produced transparent support A, followed by drying, to thereby form a polymer film. Thus-formed polymer film was rubbed in the direction parallel to the slow axis of the transparent support A, to thereby obtain an alignment film.

### (Formation of First Optically Anisotropic Layer)

On the alignment film manufactured as described in the above, a first optically anisotropic layer was formed. More specifically, 3.8 g of exemplary compound (I-4) of the present invention, 152 mg of a photo-polymerization initiator (Irgacure 819, from Ciba Specialty Chemicals K.K.), and 15 mg of an additive 3 were dissolved into 1,1,2-trichloroethane to thereby prepare a coating liquid. The coating liquid was applied to a rubbed surface of the alignment film formed on the film as described in the above, heated at 135° C. for 1 minute, and then cooled to 110° C. at a cooling rate of 5° C./minute, so as to proceed alignment. After adjusting the oxygen concentration of the atmosphere to 1% or below, the coating, while being kept at 110° C., was cured under UV irradiation using a high-pressure mercury lamp at an irradiation energy of 100 mW/cm² for 10 seconds so as to fix molecules in the alignment state, and the film was then allowed to stand for cooling to room temperature so as to form the first optically anisotropic layer. Thus-formed first optically anisotropic layer was found to have the slow axis in parallel with the longitudinal direction (direction of rubbing) of the transparent support A, and Re(0) at 550 nm was found to be 87 nm.

Thus-produced stack of the transparent support A and the first optically anisotropic layer, and cellulose triacetate film Fujitac TD80UF were respectively bonded to either of surfaces of the polarizer film produced according to the method described in the above-mentioned Laid-Open patent publication, using a polyvinyl alcohol-base adhesive, to thereby produce an integrated upper polarizer plate. Based on the horizontal line (0°) as observed in a normal direction from the upper side, the layers were stacked so that the slow axis of the protective film for the upper polarizer plate was along with the 0° direction, the slow axis of the transparent support A was along with the 90° direction, and the absorption axis of the polarizer film was along with the 0° direction. Thus-produced integrated polarizer plate composed of the upper polarizer plate and the first optically anisotropic layer was disposed in the liquid crystal display device, so that the first optically anisotropic was more closer to the upper liquid crystal cell substrate.

A VA mode liquid crystal display device was produced similarly to as described in Example 2 of Japanese Laid-Open Patent Publication “Tokkai” No. 2006-126768, except that the integrated upper polarizer plate produced as described in the above was used, and leakage light was measured according to the method described in paragraphs [0221] to [0222] of the Laid-Open Patent publication.

### Comparative Example 4

A VA mode liquid crystal display device was produced as described in Example 2 in paragraphs [0199] to [0222] of Japanese Laid-Open Patent Publication “Tokkai” No. 2006-126768, and leakage light was measured according to the method described in paragraphs [0221] to [0222] of this Laid-Open Patent publication.

Results of measurement of the leakage light in Example 6 and Comparative Example 4 are shown in Table 2 below. As is known from the results shown in Table 2, the VA mode liquid crystal cell was optically compensated in an exact manner by using the optically anisotropic film prepared using the compound of the present invention, and thereby the liquid crystal display device causative of only a small degree of light leakage in oblique directions, and has a high contrast, could be produced.

TABLE 2

| Compound used for | | Transmittance | |
|---|---|---|---|
| producing a first | | at angle of | |
| anisotropic layer of | Front | elevation of | |
| polarizer plate | transmittance | 60° | |
| Compound described in | 0.05% | 0.1% | Comparative |
| “Tokkai” No. | | | Example 4 |
| 2006-126768 (IV-2) | | | |
| Compound of present | 0.03% | 0.08% | Example 6 |
| invention (I-4) | | | |

What is claimed is:

1. A compound represented by a formula (I) below:
Q¹-SP¹—X¹-A-B—C-D-X²—SP²-Q² (I)
where, Q¹ and Q² respectively represent a polymerizable group; SP¹ and SP² respectively represent a spacer group; X¹ and X² respectively represent a linking group; and A, B, C and D respectively represent a divalent group selected from formulae IIa, IIb and IIc below: 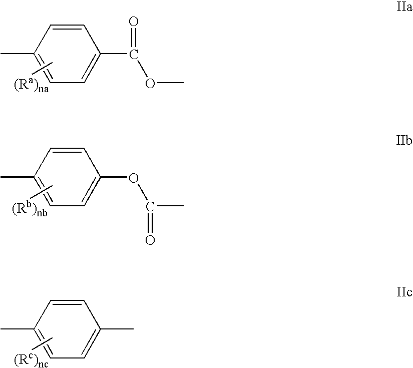
where, R^{a}, R^{b} and R^{c} respectively represent a substituent group, na, nb and nc respectively represent an integer of 0 to 4, a plurality of R^{a}, R^{b} or R^{c} may be same or different each other when na, nb and nc are respectively integers of 2 or more;
provided that at least two of A, B, C and D is a divalent group represented by the formula IIa, or at least two of them is a divalent group represented by the formula IIb.

2. The compound of claim 1, wherein Q¹ and Q² in the formula are represented by any one of the formulae (Q-101) to (Q-106) below: 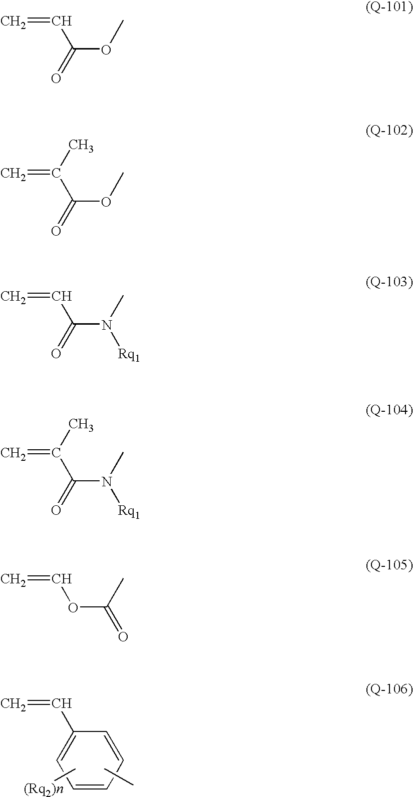
where, Rq1 represents a hydrogen atom, alkyl group, or aryl group; Rq2 represents a substituent group; and n is an integer of 0 to 4.

3. The compound of claim 1, wherein -A-B—C-D- in the formula is a group selected from Group I below: Group I

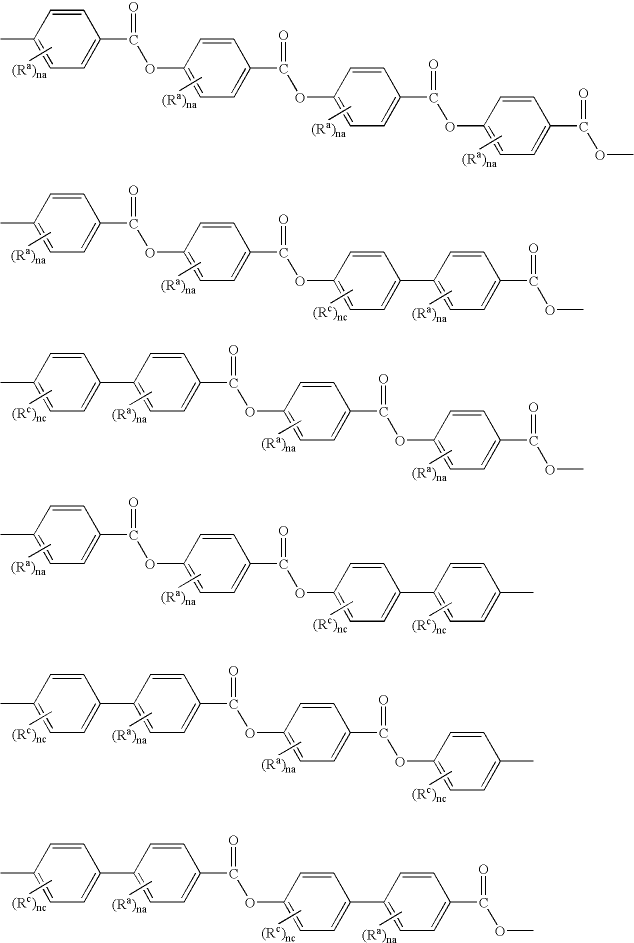

4. A liquid crystal composition comprising at least one compound represented by a formula (I) below:
Q¹-SP¹—X¹-A-B—C-D-X²—SP²-Q² (I)
where, Q¹ and Q² respectively represent a polymerizable group; SP¹ and SP² respectively represent a spacer group; X¹ and X² respectively represent a linking group; and A, B, C and D respectively represent a divalent group selected from formulae IIa, IIb and IIc below: 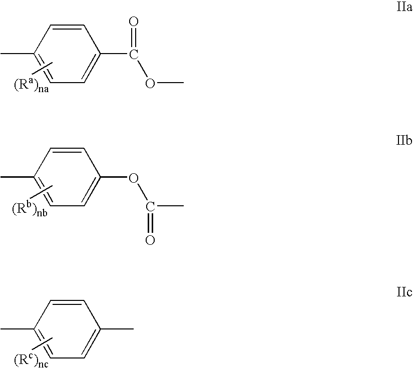
where, R^{a}, R^{b} and R^{c} respectively represent a substituent group, na, nb and nc respectively represent an integer of 0 to 4, a plurality of R^{a}, R^{b} or R^{c} may be same or different each other when na, nb and nc are respectively integers of 2 or more;
provided that at least two of A, B, C and D is a divalent group represented by the formula IIa, or at least two of them is a divalent group represented by the formula IIb.

5. An anisotropic material formed by curing a liquid crystal composition as set forth in claim 4.

6. A protective film for a polarizer plate comprising an anisotropic material as set forth in claim 5.

7. An optical compensation film comprising an anisotropic material as set forth in claim 5.
